(19) United States
(12) Patent Application Publication
(10) Pub. No.: US 2005/0125346 A1
(43) Pub. Date: Jun. 9, 2005

(54) Method and system for calculating and presenting bankruptcy preference payment defenses

(76) Inventor: Kurt A. Winiecki, Chicago, IL (US)

Correspondence Address: Vasilios D. Dossas;Niro, Scavone, Haller & Niro, Suite 4600, 181 West Madison Street, Chicago, IL, 60602, US

(21) Appl. No.: 10/727,794

(22) Filed: Dec. 4, 2003

(51) Int. Cl. G06F 17/60

(52) U.S. Cl. 705/40

(57) ABSTRACT

Automated methods and systems for separately calculating the contemporaneous exchange for new value defense, the ordinary course of business defense and the subsequent new value defense to claims for the return of preference payments made pursuant to the United States Bankruptcy Code. The inventions further contemplate combining the subsequent new value and ordinary course of business calculations and providing numerous results based on any of several ranges of values that may depict a range of days within which a bankruptcy debtor's payments for products or services are presumed to be made within the ordinary course of business.

### FIELD OF THE INVENTION

The inventions described herein relate generally to methods and systems for the analysis of preference payments under the Bankruptcy Code of the United States. More specifically, the inventions relate to determining defenses to claims for the return of Preference Payments, particularly the Contemporaneous Exchange for New Value Defense, the Ordinary Course of Business Defense and the Subsequent New Value Defense, and various combinations and permutations of these defenses.

Definitions of Terms

The following terms are used in the specification and claims of the patent and are intended to have their broadest meaning as identified below, consistent with the requirements of law:

Assumed Payment Time—the Payment Time assumed to be the middle of an OCB Protected Range.

CENV—Contemporaneous,Exchange for New Value

Claim—any manner in which a Claimant seeks to recover Preference Payments including without limitation a lawsuit or demand for recovery of Preference Payments.

Claimant—one who pursues a Claim including without limitation, a Debtor, a Trustee, a court appointed committee, or a collection firm.

Code—that section of the United States Code referred to as the Bankruptcy Code, 11 U.S.C. § 101 et seq.

Contemporaneous Exchange for New Value Defense (also referred to as CENV Defense)—the Defense specified in 11 U.S.C. § 547(c)(1) and by law in which a Preference Payment may be retained by a Recipient if the Recipient provides new value to the Debtor contemporaneously with the receipt of the Preference Payment.

Contemporaneous Exchange for New Value Time (also referred to as CENV Time)—the number of days set by one who applies the CENV Defense that represents the time within which a Preference Payment will be considered to have been made contemporaneously with the Recipient's providing of new value to the debtor, such that Preference Payments whose Payment Times are less than or equal to the CENV Time are protected by the CENV Defense.

Day Spread—the number of days added to and subtracted from the Assumed Payment Time to provide the lower and upper ends of the OCB Protected Range.

Defense—a Preference Payment Defense

Demand—any type of demand or lawsuit, regardless of its name or form, seeking recovery of a Preference Payment or Preference Payments.

Debtor—an entity that has filed a bankruptcy petition or for whom its creditors has filed a bankruptcy petition. This term also includes multiple debtors whose cases are consolidated and/or filed jointly . . . any Trustee in control of a Debtor's assets.

Exposure—the amount of a Recipient's liability for a Preference Payment Demand, that is, all Preference Payments unable to be defended and retained by a Recipient by virtue of a Defense.

Historical Average Payment Time—the average Payment Time for some set period of time prior to the preference period, such as six months, nine months, one year, eighteen months or two years.

Historical Period—a period prior to the Preference Period that is determined in some manner to represent the historical ordinary course of business payment history of the Debtor to the Recipient.

Invoice—any expression evidencing the value of goods or services provided to a Debtor.

Invoice Amount—the value of goods or services for which payment is sought pursuant to that Invoice.

Invoice Date—the date on which goods or services were provided by a Recipient to a Debtor, which is often, but not need be, the date on an invoice describing the goods or services provided to the Debtor.

Invoice Number—a reference number on an Invoice that identifies the Invoice.

Line of Data—any group of data related by any common piece of data such as Reference Number, Invoice Number, Provided Date, Invoice Amount, or Payment Date. In this description, a Line of Data typically consists of a grouping of one Reference Number, Invoice Number, Provided Date, Invoice Amount, and Payment Date (but may exclude pieces of data and include other pieces of data) all relating to the same Preference Payment, Invoice Number, etc. A Line of Data is not limited to pieces of data found in proximity with one another, on the same row in a spreadsheet, or on the same spreadsheet.

New Value Invoice Amount—an Invoice Amount related to a group of replicated data that was replicated to calculate and display subsequent new value provided when combining and applying the OCB and SNV Defenses.

New Value Invoice Number—an Invoice Number related to a group of replicated data that was replicated to calculate and display subsequent new value provided when combining and applying the OCB and SNV Defenses.

New Value Payment Date—a Payment Date related to a group of replicated data that was replicated to calculate and display subsequent new value provided when combining and applying the OCB and SNV Defenses.

New Value Payment Time—a Payment Time related to a group of replicated data that was replicated to calculate and display subsequent new value provided when combining and applying the OCB and SNV Defenses.

New Value Provided Date—a Provided Date related to a group of replicated data that was replicated to calculate and display subsequent new value provided when combining and applying the OCB and SNV Defenses.

New Value Reference Number a Reference Number related to a group of replicated data that was replicated to calculate and display subsequent new value provided when combining and applying the OCB and SNV Defenses.

OCB—Ordinary Course of Business.

Ordinary Course of Business (also referred to as Ordinary Course; OCB)—the way, including the methods, manners, terms, etc., by which a Debtor regularly conducts its business as OCB is clarified and defined by 11 U.S.C. § 547(c)(2) and by pertinent law.

Ordinary Course of Business Defense (also referred to as Ordinary Course Defense; OCB Defense)—the Defense specified in 11 U.S.C. § 547(c)(2) and further defined by law in which a Preference Payment may be retained by a Recipient if the Preference Payment was made within the ordinary course of business.

Ordinary Course of Business Protected Range (also referred to as OCB Protected Range)—that range of Payment Times that indicates the range within which a Preference Payment must be received in order to be protected by the OCB Defense.

Payment Date—the date on which a Debtor is deemed to have made a payment for the goods or services related to a particular Invoice or to particular goods or services provided to the Debtor. In the case of a Debtor's payment by check, the United States Supreme Court, in certain circumstances, has held that the Payment Date is the date the bank honors the check, not the date the Recipient receives the check. Because it is much easier to determine when a Recipient receives a check than to determine when the bank honors the check, typical practice is to use the date the Recipient receives the check rather than the date of honor as the Payment Date. It is contemplated that different definitions of Payment Date, such as, but not limited to, the date a Recipient receives a check or the date the bank honors the check, may be used in the inventions.

Payment Time—the number of days from the Provided Date to the Payment Date and typically calculated by subtracting the Provided Date from the Payment Date.

Payment Time Range—the range between the lowest Payment Time and the highest Payment Time in a period of time such as a Historical Period or the Preference Period.

Preference Payment—a payment made by a Debtor and received by a Recipient, the receipt of which falls within the Preference Period. Preference Payment includes the plural Preference Payments. The plural term Preference Payments encompasses the singular term Preference Payment.

Preference Payment Date—the date on which a Debtor makes a Preference Payment for the goods or services related to a Invoice or to particular goods or services provided to the Debtor. In the case of a Debtor's payment by check, the Payment Date has been held by the United States Supreme Court to be the date the check is honored by a bank, not the date the Recipient received the check. Because it is much easier to determine the date a check was received than determining when it cleared the bank, typical practice is to use the check's receipt date rather than the date of honor as the Payment Date. It is contemplated that different definitions of Preference Payment Date, such as the date a Recipient receives a check or the date the check is honored, are recognized by these inventions.

Preference Payment Defense—any method or manner of reducing a Recipient's Exposure specified in the Code, specifically recognized by law or otherwise, including without limitation the defenses to Demands to recover Preference Payments specified 11 U.S.C. § 547(c). For example, receiving a payment for goods provided prior to shipping the goods does not result in an antecedent debt to the recipient (one element of a Preference Payment pursuant to 11 U.S.C. § 547(b)). Accordingly, prepayment would fall under the definition of Preference Payment Defense even though it is not one of the specific defenses provided in § 547(c) of the Code.

Preference Period—the 90-day period prior to the filing of a Debtor's bankruptcy petition. It is contemplated that different definitions of Preference Period, such as the potential different period resulting from applying Bankruptcy Rule 9006(a) and counting 90 days forward from the Preference Payment Date (which may result in a longer than 90-day period if the 90th day counting forward falls on a weekend), are recognized by these inventions.

Preference Period Data—the data related to Preference Payments or new value provided, including data related to new value provided within the Preference Period which was not paid.

Provided Date—the date that the Recipient is deemed to have provided goods or services to the Debtor.

Protected Range—see OCB Protected Range.

Recipient—one who received a Preference Payment.

Reference Number—a number or other unique character that is added to a Line of Data in a separate column or by any other method so that when the order of the Lines of Data is changed, a user can find that Line of Data using its Reference Number.

SNV—Subsequent New Value

Source—any device, such as computers, laptops, modems, servers, telephones, facsimile machines, photocopiers, computer disk, e-mail, regular mail, express mail, courier mail, courier, Internet, Intranet, LAN, WAN, POTS, PSX, or any device that may be in communication with one or more network connections for receiving data from a server or servers over a network, that has access to appropriate data that is, has been, or can be manipulated into the format described in step 110 or any other step, such that the data may be manipulated copied, changed, etc. such that it is in a form that may be input into database(s) or data store(s) and used in the inventions.

Subsequent New Value (also referred to as SNV)—the value of goods or services provided by a Recipient to a Debtor within the Preference Period that is subsequent to a Preference Payment, as clarified and defined by 11 U.S.C. § 547(c)(4) and by law.

Subsequent New Value Defense (also referred to as SNV Defense)—the Defense specified in 11 U.S.C. § 547(c)(4) and further defined by law in which a Preference Payment may be retained by a Recipient if the Recipient provides new value in the form of goods or services to the Debtor within the Preference Period subsequent to the Recipient's receipt of a Preference Payment.

Trustee—one who takes control of a Debtor's assets in a bankruptcy, which may be the debtor-in-possession of its own assets.

Where alternative meanings are possible, the broadest meaning is intended. All other words in the claims are intended to be used in the normal, customary usage of grammar and the English language.

### BACKGROUND OF THE INVENTION

One goal of the Code is to fairly distribute the assets of a Debtor to its creditors. The Code sets forth a priority system providing creditors with higher priority to be paid in full from a Debtor's assets or proceeds of a Debtor's assets prior to payment to those creditors with lesser priorities. If there exists any priority class of creditors for which the Debtor's assets are insufficient to pay such claims in full, all creditors with that same priority relationship to the Debtor will be paid from the available assets pro rata, that is, in proportion of the creditor's individual claim to the claims of all creditors entitled to the same priority treatment. Creditors holding lesser priority relationships to the Debtor will receiving nothing.

To help achieve the goal of equitable distribution to creditors, the Code provides that a Claimant, may seek to recover Preference Payments for distribution to creditors. Under the Code, it is presumed that during the Preference Period, the Debtor was insolvent and paid certain creditors while failing to pay others. Thus, the Debtor presumably preferred certain creditors over others. In order to more fairly distribute a Debtor's assets to creditors under its priority scheme, the Code allows-the Debtor to recover Preference Payments.

The Code provides Recipients faced with a Demand several Defenses that allow the Recipient to retain Preference Payments. The three most frequently used defenses are: (1) the Contemporaneous Exchange for New Value Defense in which the Debtor made a Preference Payment that was a substantially contemporaneous exchange for new value provided to the Debtor; (2) the Ordinary Course of Business Defense in which the Preference Payment was made in the ordinary course of business; and (3) the Subsequent New Value Defense in which the creditor provided the Debtor with new value for the Debtor within the Preference Period and subsequent to receiving a Preference Payment.

Contemporaneous Exchange for New Value Defense

Utilizing the CENV Defense typically entails examining four pieces of data for each Invoice that was paid with a Preference Payment: (1) the Invoice Number; (2) the Provided Date; (3) the Invoice Amount; and (4) the Payment Date.

The Provided Date is typically assumed to be the Invoice Date. However, if goods are not shipped or services are not provided on the Invoice Date, a date other than the Invoice Date may be used as the Provided Date. For example, if a Recipient's business practice is to invoice product two days after shipment, then the date two days prior to that Recipient's Invoice Date could be deemed to be the Provided Date. Similarly, if a service provider such as a staffing company invoices its services on the last day of each two-week period, then the Provided Dates could be each day service was provided during that two-week period. In that case, the cost of the services on the invoice could be apportioned to each day service was provided.

To determine whether the CENV Defense applies, one must determine the time period that represents a contemporaneous exchange. The Recipient often determines, without consultation with the Debtor or Trustee, the CENV Time in order to calculate the Contemporaneous Exchange Defense. If that initial assumption regarding CENV Time changes through consultation with the Trustee, by a bankruptcy judge's determination, or for any other reason, the amounts protected by the CENV Defense may change. Changes in the Exposure after applying the CENV Defense will necessitate the recalculation of other Defenses, such as the Ordinary Course and Subsequent New Value Defenses, in order to determine a Recipient's Exposure.

Often a Debtor will argue that the CENV Time is zero, that is, that a Debtor's payment to a Recipient must be made on the same day that the product or services were provided in order to be a contemporaneous exchange. A Recipient may be able to convince the Debtor (or judge) that the Preference Payments were made contemporaneously with the providing of new value to the Debtor if the CENV Time were higher than zero days, such as three days. The Preference Payments deemed to be exchanged contemporaneously for new value are protected by the CENV Defense.

Ideally, such protected Preference Payments should be removed from the existing data such that the remaining data does not include those Preference Payments protected by the CENV Defense. Other Defenses can then be applied to the remaining data. However, removal of the Preference Payments protected by the CENV Defense is typically performed manually. Thus, one may fail to recognize and remove all Preference Payments whose Payment Times indicate a contemporaneous exchange, especially with large amounts of data. Those Preference Payments not removed remain in the data and, unless other Defenses apply, contribute to the Recipient's Exposure. Therefore it is a known problem in the art that the manual removal of protected Preference Payments, regardless of which Defense protects the Preference Payment, results in errors that may erroneously increase Exposure.

Ordinary Course of Business Defense

Another defense that may be applied is the OCB Defense. The OCB Defense provides that a Recipient may retain a Preference Payment made in the ordinary course of business. Applying this defense typically entails determining the OCB Protected Range, which is a range of Payment Times such that, if a Payment Time for a particular Preference Payment falls within that OCB Protected Range, the Preference Payment is deemed to have been made within the OCB and is protected by the OCB Defense.

The first step in determining the OCB Protected Range is determining an Assumed Payment Time, which is the Payment Time assumed to be the middle of the OCB Protected Range. Often the Historical Average Payment Time is used as the Assumed Payment Time. Often removed from the Historical Period data used in calculating the Historical Average Payment Time are those Payment Times that are deemed to be anomalies or the data related to those payments known to have been made outside the OCB, such as payments made in a Payment Time greater than a certain number of days, such as 100, payments made in a Payment Time less than a certain number of days, such as 20, or payments known to have been made outside the OCB such as a one-time contract with the creditor paid on different payment terms, invoices that are known to have been delayed due to misplacement, or invoices that were disputed and paid only after negotiation. Conventionally, manipulation of Historical Period data and the Historical Average Payment Time calculations are performed manually.

Assumptions as to which payments should be removed from the Historical Period data are typically made by the Recipient, Trustee, Debtor or whoever is calculating the Historical Average Payment Time without discussion or agreement with the other party to the Claim. A change in initial assumptions regarding which data to include in the Historical Period data, due to negotiation, as more information regarding those payments becomes available, pursuant to a judge's order, or for any other reason, necessitates removal of certain data from the Historical Period data, which may change the Historical Average Payment Time. Changing the Historical Average Payment Time will likely change the Assumed Payment Time and necessitates recalculating the OCB Defense and any other subsequently-applied Defenses, a time consuming and costly process. Therefore it is a known problem in the art that changes in Historical Average Payment Times and Assumed Payment Times lead to iterative calculation processes which are expensive and time consuming.

Once the Assumed Payment Time is determined, the Protected Range must be determined. To determine the Protected Range, one must first determine the Day Spread, which is the number of days added to and subtracted from the Assumed Payment Time to provide the lower and upper bounds of the OCB Protected Range. For instance, if the Assumed Payment Time is 44 days and it is determined that the appropriate Day Spread is 3 days, one would add 3 to, and subtract 3 from, the Assumed Payment Time to conclude that the OCB Protected Range is from 41 to 47 days. In other words, based on an Assumed Payment Time of 44 and a Day Spread of 3, those preference payments made between 41 to 47 days are protected by the OCB Defense, assuming no other circumstances indicate that such payments were made outside the OCB.

The next step typically requires removing the Preference Payments made within the Protected Range from the Preference Period Data and adding those Preference Payments not protected by the OCB Defense to determine the Recipient's Exposure. Removing the Preference Payments protected by the OCB Defense is often performed manually by typing or re-typing the Preference Period Data in a text format excluding those Preference Payments protected by the OCB Defense, removing from a previously-typed text format those Preference Payments protected by the OCB Defense, or, if the Preference Period Data is in a spreadsheet format, electronically cutting those Preference Payments protected by the OCB Defense out of the Preference Period Data.

Manually removing Preference Payments made within the OCB Protected Range is time consuming and prone to human error. If the Assumed Payment Time is changed through negotiation with the Trustee, because of new information regarding the data, or for any other reason, one must calculate a new OCB Protected Range, remove the Preference Payments made within the OCB Protected Range from the Preference Period Data, and recalculate the Recipient's Exposure by adding those Preference Payments not made within the OCB Protected Range. If the Day Spread is changed through negotiation with the Trustee, because of new information regarding the data, or for any other reason, one must calculate a new Protected Range, remove the Preference Payments made within the OCB Protected Range from the Preference Period Data, and recalculate the Recipient's Exposure by adding those Preference Payments not made within the OCB Protected Range. Often, the resulting data after application of the OCB Defense is not reconciled with the original data to verify that the result is based on correct data. Therefore it is a known problem in the art that such recalculations and reconciliations are prone to human error, time consuming, and typically performed by attorneys at a substantial cost to the Recipient.

Subsequent New Value Defense

Another Defense typically applied is the SNV Defense, which provides that Preference Payments may be retained if after a Preference Payment is made, the creditor provides subsequent new value to the Debtor on account of which the Debtor did not make an otherwise unavoidable transfer to or for the benefit of such creditor. In other words, if a Recipient receives a preference payment of $1,000 then subsequently provides $800 worth of goods or services to the Debtor within the Preference Period, the Recipient may retain $800 of the $1,000 Preference Payment. If the Debtor or Trustee does not pay for the SNV, the SNV Defense will apply. Some jurisdictions, however, appear to hold that the SNV must remain unpaid by the Debtor in order for the SNV Defense to apply, and the inventions can apply either interpretation.

Calculation of the SNV Defense typically entails sorting Preference Period Data, including the Invoice Number, Provided Date, Invoice Amount, and Payment Date of each Preference Payment, by Payment Date in ascending order. A second set of data including Invoice Number, Provided-Date, Invoice Amount, and Payment Date for each Provided Date falling within the Preference Period is then sorted by Provided Date in ascending order. The second set of data is then merged with the sorted Preference Period Data so that the Payment Dates of the Preference Period Data and the Provided Dates of the second set of data are arranged in ascending chronological order. Typically, Payment Dates that are the same as Provided Dates precede the Provided Date, but the inventions contemplate that Provided Dates made on the same day as a Payment Date can be assumed to occur chronologically prior to the Payment Date.

Using the combined data sorted by Payment Date and Provided Date, beginning with the first Preference Payment, Preference Payments from the Preference Period Data are added together in chronological order and Invoice Amounts from the second set of data (the subsequent new value provided data or replicated data) are subtracted in chronological order so that a running total of the Recipient's Exposure is kept. The final Exposure number will be the Recipient's Exposure after application of the SNV Defense. It is generally understood that a Recipient's Exposure cannot decrease below zero, but the inventions contemplate that, optionally, an assumption may be made that a Recipient's Exposure may decrease below zero.

Currently used processes of applying the SNV Defense include manual manipulation of data and manual calculation. For example, if an electronic text or electronic spreadsheet format is used for manipulating and displaying the data, which are the typical methods, sorting the Preference Period Data by Payment Date and sorting the second set of data by Provided Date are typically performed manually by typing, re-typing, or inserting by cutting and pasting the data in the preferred order. Merging the two data sets typically includes manually inserting blank rows into one data set, cutting data from the other data set and inserting it into the first data set so that the two data sets are combined in the proper order. Moreover, the calculations of a Recipient's Exposure are often performed with an exterior device, such as a hand held calculator, and the resulting calculation is inserted into the data.

It is a known problem in the art that manually sorting, manipulating, and performing calculations on the data is time consuming and prone to human error. If any of the data is changed through negotiation with the Trustee, because new information regarding the data is discovered or for any other reason, the data must be sorted again, the two data sets must be merged together again, and the Exposure calculations must be performed again. Often, the resulting data after application of the OCB Defense is not reconciled with the original data to verify that the calculations were correct.

Concurrent Analysis of the OCB and SNV Defenses

If the OCB Defense and SNV Defense are both applicable to a Recipient's Preference Payments, those defenses must be applied at the same time and in the same analysis. Applying the two Defenses separately and adding the two separate Exposures may result in the Recipient's Exposure being reduced by the same Preference Payment twice, once through each Defense. It is generally understood that such dual reduction of Exposure is incorrect under the Code, but some believe it is acceptable, and the inventions can accommodate either theory.

When both the OCB and the SNV Defenses apply to a Recipient's Preference Payments, the Recipient's Exposure is often estimated by combining in some way the Exposures resulting from applying the two Defenses separately, but not by combining and calculating the two Defenses in a single analysis. Those analyses that combine the two Defenses often do so by manually sorting two sets of data that include the Invoice Number, Invoice Amount, Provided Date and Payment Date for each Preference Payment by Payment Date as if one were conducting the SNV Defense, determining whether each Preference Payment is, in whole or part, protected by the OCB or SNV Defense, and keeping a running total of the Exposure.

Therefore, it is a known problem in the art that, to the extent that the data of each Preference Payment is analyzed individually and manually to determine which Defense may apply, this process is time consuming and prone to human error. Like the OCB Defense, changes to the Assumed Payment Time or Day Spread cannot be made without reexamining each Preference Payment to see if it falls within the new OCB Protected Range and is protected by the OCB Defense. Like the SNV Defense, the combination of the OCB and SNV Defenses typically includes manually sorting, manipulating, and performing calculations on the data and must be repeated if any data changes through negotiation with the Trustee, modified legal assumptions, because new information regarding the data is uncovered, or for any other reason. Often, the resulting data after application of the OCB and SNV Defenses is not reconciled with the original data to verify that the data manipulations and calculations were correct.

The Preference Period Data may range from a few Preference Payments to several hundred or more. Even if only a few Preference Payments were made, manual manipulations are time consuming and prone to human error, especially if the final output is not reconciled with the initial data to verify that all data has been included in the analysis. Even if only a few Preference Payments were made, a manually calculated analysis only recognizes one Assumed Payment Time and one Day Spread for the OCB Defense portion of the analysis. Changing either assumption for any reason requires calculation of another whole analysis.

For each Preference Payment Defense calculation, it is a known problem that current formats used to present resulting data are difficult to understand, explain to clients or other parties, or use in negotiations. The current methods of calculating Defenses fail to provide any mechanism to verify that the resulting (or output) data ties to the original (or input) data. Current methods of presenting resulting data fail to provide a mechanism for electronically searching for pieces of data such as Invoice Numbers or Preference Payments Dates.

Thus, there is a need in the art for more accurate, more reliable, more cost effective, and more automated systems and methods for analyzing a Recipient's Preference Payment Defenses. Further, there is a need in the art for systems and methods that present the results of Preference Payment Defense analyses in formats that are easy to read and explain to others.

### SUMMARY OF THE INVENTIONS

Software enabled, automated or semi-automated methods and systems for calculating a Recipient's Exposure to a Claim for recovery of Preference Payments pursuant to the United States Bankruptcy Code (11 U.S.C. § 547(b)) after applying, and combining when appropriate, Defenses to such Claim, such as the CENV Defense (11 U.S.C. § 547(c)(1)), OCB Defense (11 U.S.C. § 547(c)(2)), and the SNV Defense (11 U.S.C. § 547(c)(4)), and presenting the results, is disclosed. It should be noted that the sections of the Code specifically cited in this disclosure were correct at the time of filing of this application. As with most regulatory code, it is to be expected that newer revisions of the Code may result in changes to section, chapter or paragraph numbering.

To apply the CENV Defense, one begins by setting a CENV Time at or below which it is presumed that a Recipient's provision of goods or services to a Debtor was made contemporaneously with the Preference Payment Date. The inventions allow for formulaic calculation of the Payment Time of Preference Payments, which eliminates the human error and time associated with determining the Payment Time manually. The inventions allow for automatic removal from the data all Preference Payments whose Payment Times equal or are less than the CENV Time. Summing the remaining Preference Payments will demonstrate the Recipient's Exposure after the CENV Defense is applied.

Current methods of applying the CENV Defense do not allow the CENV Time or the original data to be easily changed. If a Recipient originally set a CENV Time at 1 day, but then wanted to determine its Exposure if the CENV Time was 4 days, or if any of the original data were altered, the change would require manually comparing the new CENV Time with the Payment Times of the Preference Payments to determine which Preference Payments were made contemporaneously, manual removal of those protected Preference Payments, and recalculation of the Exposure. The inventions' automated method of comparing the CENV Time with the Payment Times of the Preference Payments and removing Preference Payments protected by the CENV Defense without manual data manipulation allows numerous assumptions as to CENV Times to be made and the Exposure results quickly and accurately determined. For each CENV Time used, the inventions also create a new data set of Preference Payments so that other Defenses may be applied to those Preference Payments not protected by the CENV Defense.

The inventions contemplate presenting resulting data in a desirable format. While other formats are contemplated by the inventions, it is foreseen that the preferred presentation format after the CENY Defense is applied is one that separates those Preference Payments protected by the CENV Defense from those that are not so protected. The amounts of the Preference Payments in each of the two resulting data sets are totaled and then the two totals are added together such that the total of all Preference Payments can be reconciled to the original Preference Period Data. The ability to reconcile the total amount of the Preference Payments after applying the CENV Defense with the original amounts of the Preference Payments is an improvement over the current methods.

Using the inventions, the calculation of the OCB Defense may provide numerous Exposure results based on different assumptions regarding the Assumed Payment Time and the Day Spread. This improves upon the current method which calculates one Exposure result given one assumption as to the appropriate Assumed Payment Time and another assumption as to the appropriate Day Spread. Using numerous Assumed Payment Times and Day Spreads is preferable to using one of each because if the Claimant disagrees with the OCB Protected Range, another analysis must be performed, and if the analysis is performed manually, time and money is spent. The inventions can automatically calculate Exposures, either sequentially or simultaneously, assuming a wide variety of OCB Protected Ranges, which would hopefully include all OCB Protected Ranges that a Claimant would advocate. For example, if a Recipient believes that the appropriate Assumed Payment Time is 42 days and the appropriate Day Spread is 5 days, the inventions can calculate Exposure results assuming Day Spreads from 0 to 10 days for Assumed Payment Times ranging from 37-47 days. Accordingly, if the Claimant proposes that an Assumed Payment Time of 46 days and a Day Spread of 3 days should be used, the inventions have already provided the Exposure result for those assumptions and the Recipient can negotiate accordingly by arguing that either the Assumed Payment Time or the Day Spread or both should be different. Without the inventions, different OCB analyses would need to be calculated for each set of assumptions as to Assumed Payment Time and Day Spread. The results of the inventions show how each day change in Assumed Payment Time and each day change in Day Spread affect the Recipient's Exposure. The current methods do not provide such comprehensive results and thus hamper a Recipient's or a Claimant's ability to understand how different assumptions affect Exposure, which is necessary in negotiations.

The inventions further contemplate automated or semi-automated calculation of the SNV Defense. The inventions allow for automatic sorting, arranging and manipulating the Preference Period Data and other data such that a Recipient's providing of new value to the Debtor after a Preference Payment is received is automatically recognized, those Preference Payments protected by the SNV Defense are excluded from the Exposure result, and the total Exposure after the SNV Defense is calculated without manual manipulation or manual calculation. The inventions' automated method of calculating the Exposure after applying the SNV Defense is quick and accurate.

The inventions further contemplate combining the SNV and OCB Defenses and providing numerous Exposure results based on different assumptions regarding the Assumed Payment Time and the Day Spread. The automatic calculations that combine these two Defenses improve upon the prior methods as prior methods often fail to combine the two Defenses or require the manual manipulation of data or manual calculations to combine these two Defenses. The inventions also improve upon the current methods of combining these two Defenses in that other existing methods typically calculate one Exposure result given one assumption as to the appropriate Assumed Payment Time and another assumption as to the appropriate Day Spread. Using numerous Assumed Payment Times and Day Spreads is preferable to using one of each because if the Claimant disagrees with the OCB Protected Range, another analysis must be performed, and if the analysis is performed manually, time and money is spent.

The inventions can combine the SNV and OCB Defenses automatically and calculate Exposures assuming a wide variety of OCB Protected Ranges, which would include all OCB Protected Ranges that a Claimant would advocate. For example, if both the OCB and SNV Defenses apply, and if a Recipient believes that the appropriate Assumed Payment Time is 42 days and the appropriate Day Spread is 5 days, the inventions can calculate Exposure results applying and combining both the SNV and OCB Defenses and assuming Day Spreads from 0 to 10 days for Assumed Payment Times ranging from 37-47 days. Accordingly, if the Claimant proposes that an Assumed Payment Time of 46 days and a Day Spread of 3 days should be used, the inventions have already calculated the Exposure result for those assumptions and the Recipient can negotiate accordingly by arguing that either the Assumed Payment Time or the Day Spread or both should be different. Without the inventions, different analyses combining the OCB and SNV Defenses would need to be calculated for each set of assumptions as to Assumed Payment Time and Day Spread. The results of the inventions show how each day change in Assumed Payment Time and each day change in Day Spread affect the Recipient's Exposure. The results of each analysis will automatically be provided in a two-dimensional chart for easy reference, one variable being the Assumed Payment Time and the other variable being the Day Spread. The current methods do not provide such comprehensive results and thus hamper a Recipient's or a Claimant's ability to understand how changes in assumptions affect Exposure, which is necessary in negotiations.

The inventions improve upon existing art by providing, for each Assumed Payment Date and for each assumed Day Spread, a comprehensive final product that is easily reconciled with the separate Defense calculations to ensure that the resulting data is correct, provides a running total of Exposure, which is decreased as either the OCB or SNV Defenses are applied, clearly indicates which Preference Payments are subject to which Defense, allows for any single Preference Payment to be subject to both Defenses if appropriate, totals the amounts of OCB and SNV Defenses used in the analysis, and provides that the Exposure shall not fall below zero.

Features and benefits of the present inventions include the following: (1) elimination of manual manipulations of data when calculating Defenses; (2) elimination of manual calculations when calculating Defenses and Exposure; (3) provides resulting data in formats easy to understand, explain to clients or other parties, and use in negotiations; (4) properly combines the OCB Defense and the SNV Defense; (5) properly shows which one or both of the OCB and SNV Defenses apply to a particular Preference Payment and to what extent; (6) provides a mechanism to verify that the resulting (or output) data ties to the original (or input) data; (7) provides a mechanism for electronically searching for pieces of data such as Invoice Numbers or Preference Payment Dates; (8) changes to original (or input) data or changes in assumptions related to Defenses do not result in time consuming, costly, error-prone manual recalculation of Defenses and the Recipient's Exposure as such changes in assumptions are contemplated by the inventions or are easily input so that the results can be calculated accurately and quickly.

### BRIEF DESCRIPTION OF THE DRAWINGS

FIG. 1 depicts a block diagram illustrating a method for calculating Exposure for return of Preference Payments considering the CENV, OCB and SNV Defenses, either alone or in combination;

FIG. 2 depicts a block diagram illustrating a preferred embodiment for the preliminary manipulations of initial data into usable raw data of FIG. 1.

FIG. 3 depicts a block diagram illustrating a preferred embodiment for calculating the CENV Defense of FIG. 1.

FIG. 4 depicts a block diagram illustrating a preferred embodiment for calculating Average Payment Times and Payment Time Ranges for the Pre-Preference and Preference Periods of FIG. 1.

FIG. 5 depicts a block diagram illustrating a preferred embodiment for calculating the OCB Defense of FIG. 1.

FIG. 6 depicts a block diagram illustrating a preferred embodiment for calculating the Subsequent New Value Defense of FIG. 1.

FIG. 7 depicts a block diagram illustrating a preferred embodiment for calculating the application of both the OCB and SNV Defenses.

FIG. 8 depicts a presentation of initial data in general terms.

FIG. 9 depicts a presentation of initial data using sample actual values.

FIG. 10 depicts a new device figure.

FIG. 11 depicts a presentation of initial data sorted by Invoice Number and calculating Payment Times in general terms.

FIG. 12 depicts a presentation of initial data sorted by Invoice Number and indicating a formula for calculating Payment Times.

FIG. 13 depicts a presentation of initial data sorted by Invoice Number and calculating Payment Times using sample actual values.

FIGS. 14 and 14(a) depict a presentation of data sorted by Payment Date and split into pre-Preference and Preference Periods using sample actual values.

FIGS. 15 and 15(a) depict a presentation of data sorted by Payment Date, determination of Payment Time Range and calculation of average Payment Time with payments known to have been made outside the ordinary course of business removed and the data split into pre-Preference and Preference Periods using sample actual values.

FIG. 16 depicts a comparison of Payment Time Averages and Payment Time Ranges for the pre-Preference and Preference Periods.

FIG. 17 depicts a presentation of Preference Period Data after applying the OCB Defense in general terms.

FIG. 18 depicts a presentation of Preference Period Data after applying the OCB Defense displaying formulas.

FIG. 19 depicts a presentation of Preference Period Data after applying the OCB Defense using sample actual values.

FIG. 20 depicts a presentation of Preference Period Data after applying the SNV Defense in general terms.

FIG. 21 depicts a presentation of Preference Period Data after applying the SNV Defense displaying formulas.

FIG. 22 depicts a presentation of Preference Period Data and Exposure after applying the SNV Defense using sample actual values.

FIG. 22(a) depicts an alternative method of displaying a full presentation of Preference Period Data after applying the SNV Defense using sample actual values where the original data related to Preference Payment Payment Dates and the replicated data related to New Value Provided Dates are separated and New Value Available is not shown until after the date the first Preference Payment was made.

FIG. 23 depicts a presentation of Preference Period Data after combining and applying the OCB and SNV Defenses in general terms.

FIG. 24 depicts the original data (related to Preference Payments) to be used in combining and applying the OCB and SNV Defenses, the total Invoice Amounts of which will equal the total Invoice Amounts in an analysis, such as in FIGS. 26(a), 26(b), and 26(c).

FIG. 25 depicts the replicated data (related to Subsequent New Value) to be used in combining and applying the OCB and SNV Defenses, the total Invoice Amounts of which will equal the total New Value Invoice Amounts in an analysis, such as in FIGS. 26(a), 26(b), and 26(c).

FIG. 26(a) depicts a presentation of Preference Period Data after combining and applying the OCB and SNV Defenses using sample actual values and assuming an Assumed Payment Time of 49 days and a Day Spread of 5 days.

FIG. 26(b) depicts a presentation of Preference Period Data after combining and applying the OCB and SNV Defenses using sample actual values and assuming an Assumed Payment Time of 44 days and a Day Spread of 3 days.

FIG. 26(c) depicts a presentation of Preference Period Data after combining and applying the OCB and SNV Defenses using sample actual values and assuming an Assumed Payment Time of 48 days and a Day Spread of 10 days.

FIG. 27 depicts a partial presentation of the Exposure resulting from each combination of OCB and SNV Defenses for each assumption of Assumed Payment Time and Day Spread in a two-dimensional chart (the values being pulled from the results of applying each set of assumptions) using sample actual values.

### DETAILED DESCRIPTION OF PREFERRED EMBODIMENTS

Set forth below is a description of what is currently believed to be the preferred embodiments or best examples of the claimed inventions. Future and present alternatives and modifications to the preferred embodiments are contemplated. Any alternatives or modifications which make insubstantial changes in function, in purpose, in structure or in result are intended to be covered by the claims of this patent. Any other specific alternative scenarios that may occur in a bankruptcy or workout setting that may affect the initial or modified data not specifically referenced are intended to be covered by the claims of this patent. Recovery of Preference Payments necessarily requires interpretation of the Code, judicial opinions and other legal memoranda. Novel or little-used interpretations may present themselves from time to time. Alternative interpretations or theories affecting any aspect of Preference Payment recovery are intended to be covered by the claims of this patent.

Devices

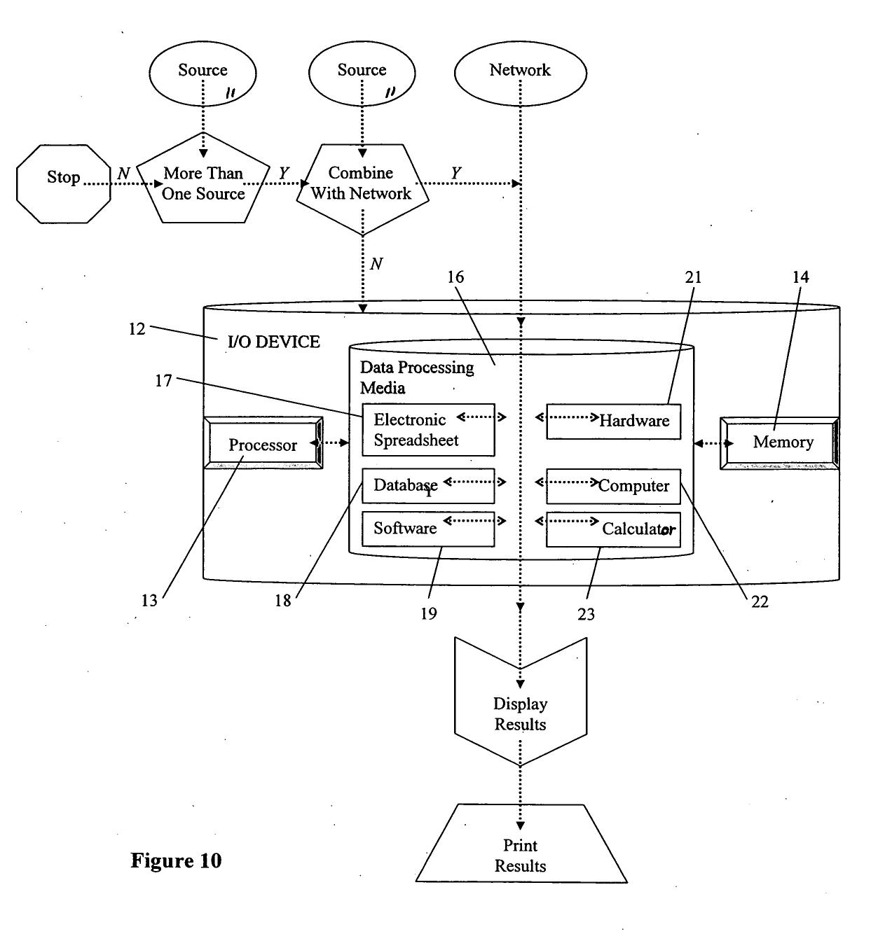

As shown in FIG. 10, it is contemplated that the system embodiments of the invention include one or more Sources 11, one or more Input/Output (I/O) Devices 12, a Processor 13 and a Memory 14. It is contemplated that the inventions will utilize a format and type of data processing media 16 that allows for data input, manipulation, calculation and output display required by the inventions. It is contemplated that the data processing media 16 may be an electronic spreadsheet 17 so that data may be inserted into the inventions, manipulated, used in calculations and displayed in any appropriate manner. However, it is also contemplated that inserting the data need not be into an electronic spreadsheet 17, but may be into any data processing media 16 such as a database 18, software storage device 19, hardware storage device 21, computer 22, calculator 23 or other means as are known in the art that allow the manipulations, calculations and output display required by the inventions. Accordingly, the data processing media 16 need not be in column/row format where each Line of Data 102 corresponds to one Preference Payment received by the Recipient (or any Invoice or portion thereof is unpaid, any one Invoice Number 111, Invoice Amount 112 or Provided Date 113), but may be in any format that allows the data to be manipulated, calculations to be performed and the results to be displayed. I/O Devices 12 maybe in communication with a network or may be in direct communication with a Source 11. I/O Devices 12 provide means for entering data into, and transmitting data from, processor 13 and memory 14. Data received by I/O Devices 12 may be immediately accessible by processor 13 or may be stored in memory 14.

Preliminary Manipulations of Raw Data

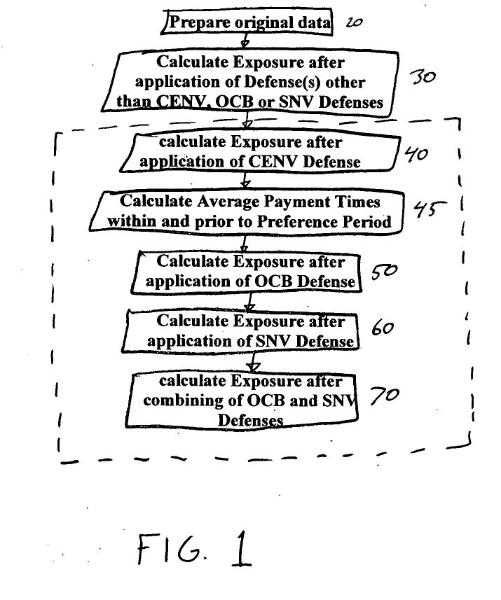

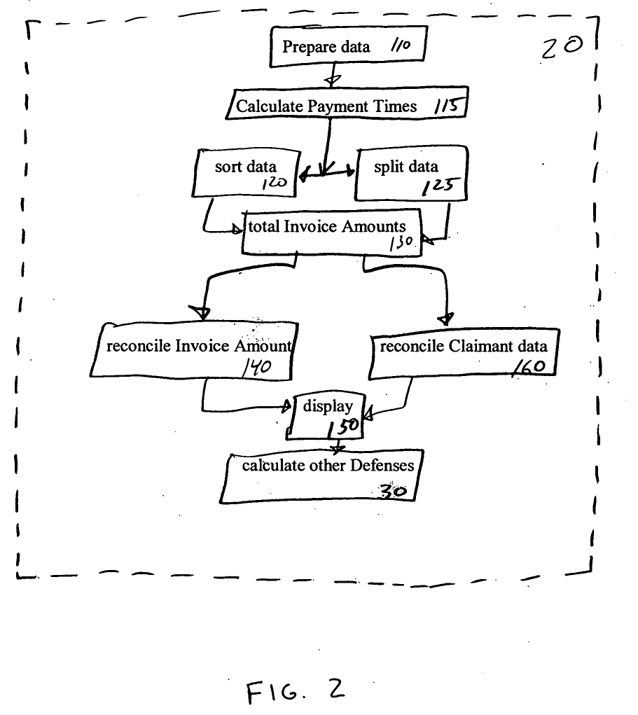

FIG. 1 depicts a block diagram illustrating a method for analyzing Preference Payment Defenses according to a preferred embodiment of this invention. A Claim is asserted by a Claimant against a Recipient of Preference Payments or another event occurs that requires calculation of Preference Defenses. In response, data is prepared for use in the invention according to a data input step 20. In the data input step, Lines of Data 102 are entered into an electronic spreadsheet 17. Exposure after application of any other Defense or method of reducing Exposure other than the CENV, OCB and SNV Defenses is calculated and results are displayed in a row/column range of spreadsheet. Exposure after application of the CENV Defense is calculated and results are displayed in a row/column range of spreadsheet. Exposure after application of the OCB Defense is calculated and results are displayed in a row/column range of spreadsheet. Exposure after application of the SNV Defense is calculated and results are displayed in a row/column range of spreadsheet. Exposure after application of the combined OCB and SNV Defenses is calculated and results are displayed in a row/column range of spreadsheet.

FIG. 2 depicts a block diagram illustrating the preliminary manipulations of original data needed to use the invention.

In data preparation step 110, Recipient, Claimant or other entity prepares the following data (or the data may be imported from any Source 11) in four columns in readable electronic spreadsheet format (or other grouping mechanism that allows a Line of Data 102 to be manipulated), for each payment received by Recipient from the date 820 days (two years plus ninety days) (if such data is available) prior to the bankruptcy filing date through the bankruptcy filing date: Invoice Number 111, Invoice Amount 112, Provided Date 113, and Payment Date 114, each four-column set of data being a Line of Data. The Invoice Number 111 may be any alpha/numeric character to represent the Invoice Number. The Invoice Amount 112 may be a value in any known value format, preferably a currency format. The Provided Date 113 may be a date in any known date format. The Payment Date 114 may be a date in any known date format.

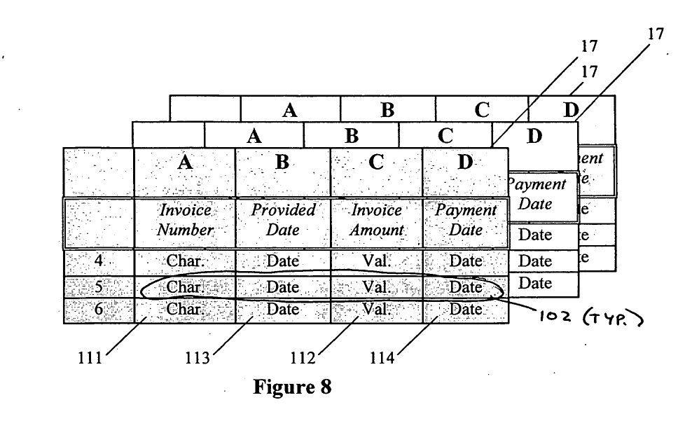

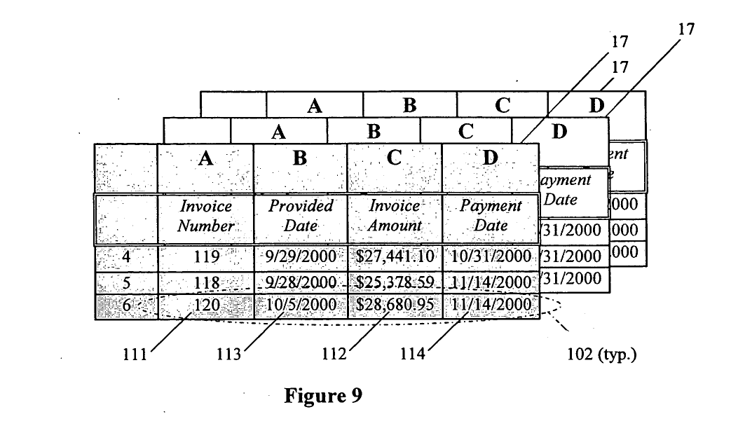

A depiction of a presentation of initial data in general terms is shown at FIG. 8. A depiction of a presentation of initial data using sample actual values is shown at FIG. 9. It is contemplated that the Provided Date for services may need to be determined by pro rating the value of the services over the number of days the services were provided. Although any method known in the art may be used for this determination, it is contemplated that the user may make such determinations. It is also contemplated that the invention may, by operation of an algorithm, make such determinations if the dates covered by any particular invoice for services are provided, such that the invention can pro rate the amount of the invoice over the dates of service so that all Provided Dates for each invoice are determined.

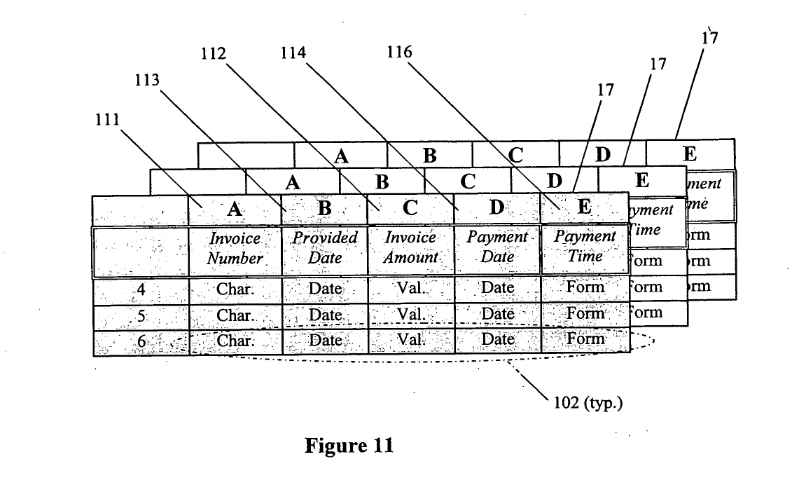

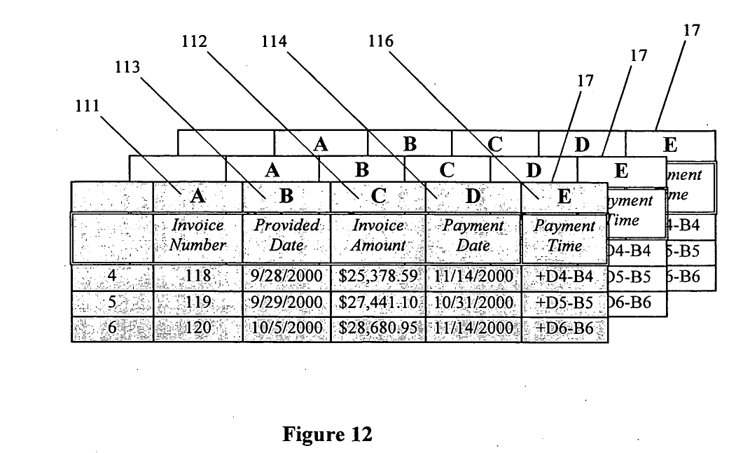

In the Payment Time calculation step 115, for each Line of Data, calculate and display the Payment Time 116. A depiction of a presentation of initial data sorted by Invoice Number 111 and calculating Payment Times 116 in general terms is shown at FIG. 11. The Payment Time 116 presents the result of a formula subtracting Provided Date from Payment Time and displaying a result in integer form using any appropriate units of time. A depiction of a presentation of initial data sorted by Invoice Number 111 and calculating Payment Times 116 using sample actual values is shown at FIG. 12.

In data sorting step 120, The invention sorts the Invoice Number 111, Invoice Amount 112, Provided Date 113, Payment Date 114 and Payment Time 116 data for each Payment Date 114 by Payment Date 114 in ascending chronological order.

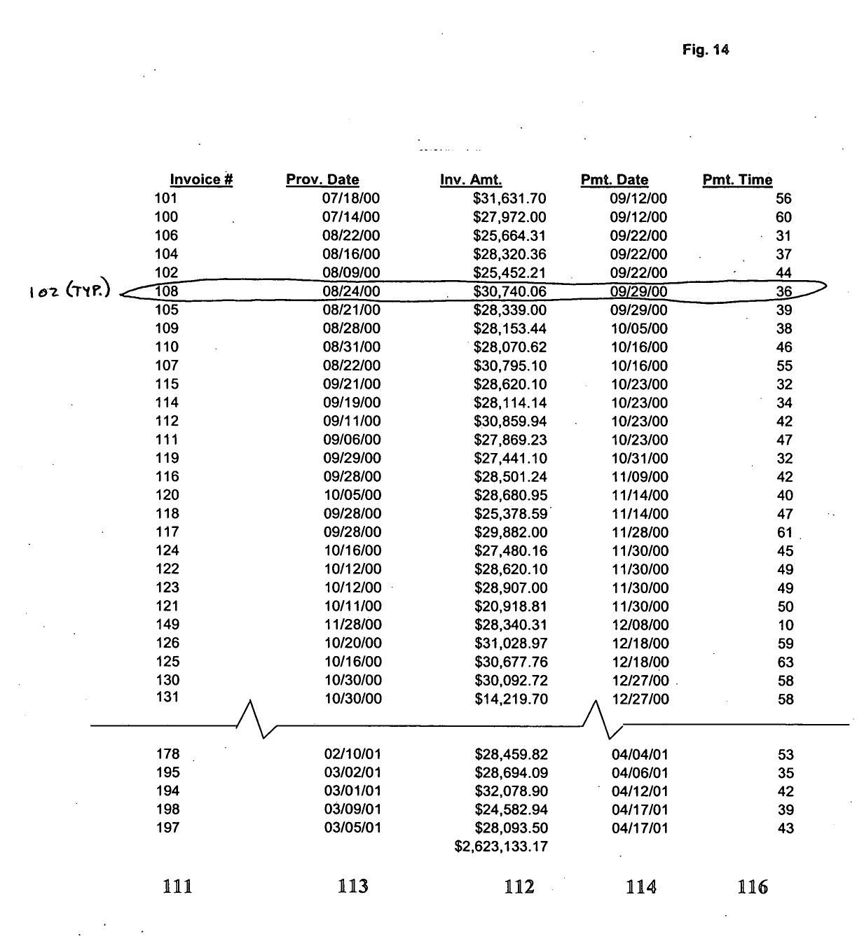

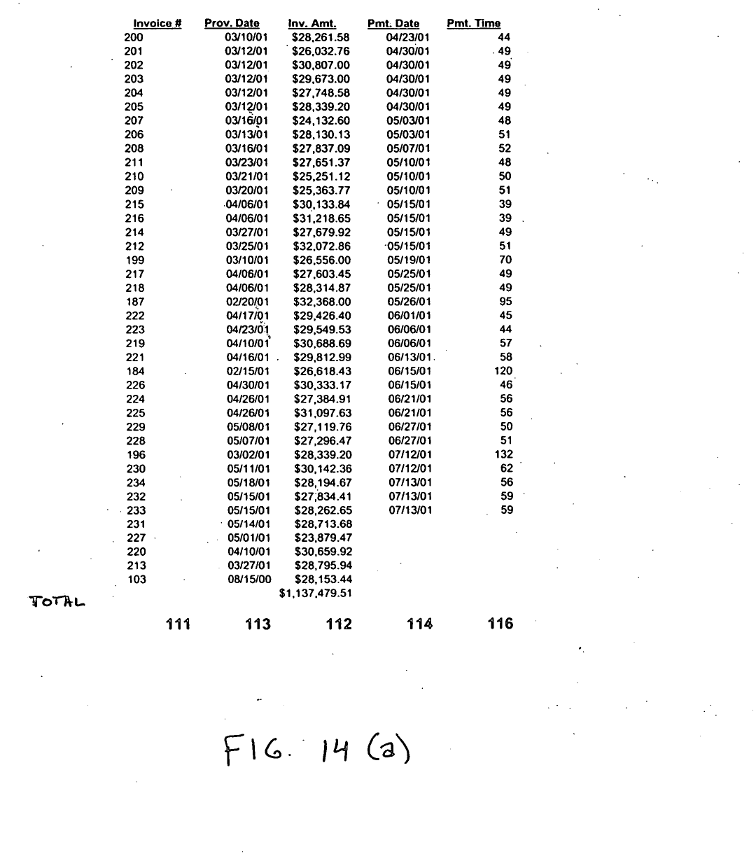

In data splitting step 125, the invention splits the data into Preference Period Data and Pre-Preference Period Data. Include in the Pre-Preference Period Data the Invoice Number 111, Invoice Amount 112, Provided Date 113, and Payment Date 114 data of all Provided Dates 113 occurring within the Pre-Preference Period, but which were never paid. The splitting function is preferably performed by a sorting feature in the spreadsheet software, but may be done by other manual or automatic methods as are known in the art. Include in the Preference Period Data, the Invoice Number 111, Invoice Amount 112, Provided Date 113, and Payment Date 114 data of all Provided Dates 113 occurring within the Preference Period, but which were not paid, in which case Payment Date would be left blank. A sample of the data after these manipulations for the Pre-Preference Period is shown in FIG. 14. A sample of the data after these manipulations for the Preference Period is shown in FIG. 14(a). The example illustrated in FIGS. 14 and 14(a) assumes a hypothetical preference period of Apr. 18, 2001 through Jul. 16, 2001. Lines of data 102 in FIG. 14(a) that report no payment date 114 or payment time 116 indicate that no payment was received from the Debtor.

It must be determined by the user whether the Invoices represented by Provided Dates 113 occurring within the Preference Period but paid after the date of filing of the Debtor's bankruptcy petition should be included in the Preference Period Data, and such determination will likely depend on the likelihood the Recipient will be able to retain the payments made after the date of filing of the Debtor's bankruptcy petition.

In an invoice totaling step 130, the invention separately totals the Invoice Amounts 112 for the Pre-Preference Period and the Preference Period, the total for the Preference Period being the total Exposure a Recipient has to a Claim prior to any Defenses being applied.

In an invoice reconciliation step 140, the invention adds the total Invoice Amounts 112 for the Pre-Preference Period and the total Invoice Amounts for the Preference Period such that the total of the Invoice Amounts 112 can be reconciled with the total Invoice Amounts 112 from the original data.

In display step 150, the invention presents the resulting Pre-Preference Period Data and Preference Period Data in a readable format in ascending order by Payment Date 114.

In Preference Payment reconciliation step 160, however, the Preference Period Data may not reconcile with the Preference Payments sought to be recovered by the Claimant. In preference payment reconciliation step 160, a Recipient may choose to try reconcile its data with the Claimant's, which may mean that the Recipient will add or remove those Preference Payments in the Recipient's data so that Recipient's data matches the Claimant's data. The Recipient may also choose not to reconcile the data and conduct the analysis on its unaltered data. The Recipient may also choose to continue two separate analyses, one with the Claimant's Preference Payment data and one with the Recipient's Preference Payment data.

Calculate and Apply Defenses Other than CENV, OCB and SNV Defenses

The step of calculating and applying Defenses other than the CENV, OCB and SNV Defenses 30 may be initiated after the data has been prepared. Other Defenses include demonstrating that one or more of the following elements of a Preference Payment have not been met: (1) a payment that is a transfer (Code § 547(b)); (2) of property of the debtor (Code § 547(b)); (3) to or for the benefit of a creditor (Code § 547(b)(1)); (4) for or on account of an antecedent debt (Code § 547(b)(2)); (5) made while the debtor was insolvent (Code § 547(b)(3), (f); (6) made during the 90-day preference period or one year for insiders (Code § 547(b)(4)); and (7) that enables a creditor to receive more than it would have in a hypothetical liquidation under chapter 7 of the Code (Code § 547(b)(5)), or Code-specified defenses such as (1) providing an enabling loan (Code § 547(c)(6)); (2) possessing a floating lien (Code § 547(c)(5)); (3) possessing a statutory lien (Code § 547(c)(6)); (4) payments for domestic relations debts (Code § 547(c)(7)); and (5) payments for small consumer transfers (Code § 547(c)(8)). Other Defenses may also include any other defense known to those in the art that has not been specifically identified above.

Calculation of Contemporaneous New Value Defense

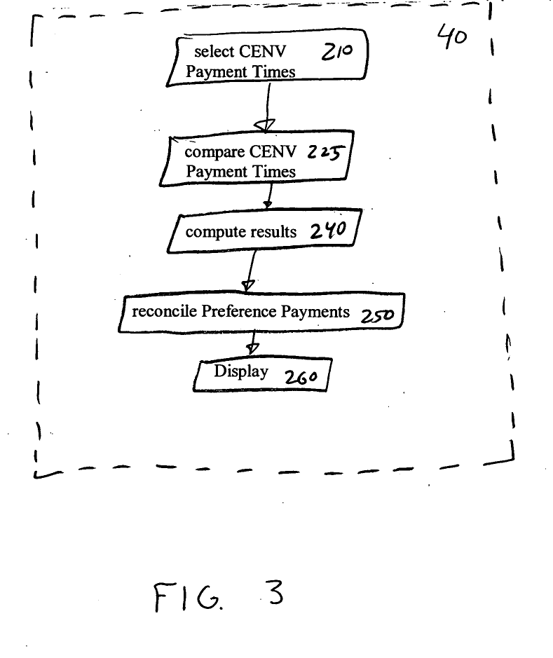

FIG. 3 depicts a block diagram illustrating a preferred embodiment for calculating the CENV Defense. In-CENV Payment Time selection step 210, one or more CENV Times are chosen. Although any manner of choosing a CENV Time or Times may be used, it is contemplated that the Recipient may determine such CENV Time to be one number such as 2, more than one number such as 0 and 3 or a range of numbers such as 0, 1, 2, and 3. In CENV Payment Time input step, the determined CENV Time or Times are input into the invention by the user. Alternatively, it is contemplated that the invention will prompt the user for such CENV Time or Times.

In CENV comparison step 225, the user determines which Preference Payments were made contemporaneously with the Recipient's providing of new value by comparing the Payment Dates 114 with the CENV Time.

Those Preference Payments that were made contemporaneously with the Recipient's providing of new value are separated from those not made contemporaneously. In CENV data separation step, the invention separates the Invoice Number 111, Invoice Amount 112, Provided Date 113, Payment Date 114 and Payment Time 116 data related to those Preference Payments whose Payment Times 116 are less than or equal to the CENV Time from the Invoice Number 111, Invoice Amount 112, Provided Date 113, Payment Date 114 and Payment time 116 data related to those Preference Payments whose Payment Times 116 are greater than the CENV Time.

In CENV result step 240, for each result based on each CENV Time used, the invention adds the Invoice Amounts 112 for those Preference Payments deemed to have been made contemporaneously in exchange for new value, the total of which is the amount protected by the CENV Defense. The invention also adds the Invoice Amounts 112 for those Preference Payments deemed not to have been made contemporaneously in exchange for new value, the total of which is the amount not protected by the CENV Defense and equals the Recipient's Exposure after the application of the CENV Defense.

In CENV reconciliation step 250, the invention adds the total amount of Preference Payments protected by the CENV Defense and the total amount of Preference Payments not protected by the CENV Defense so that the total of all Preference Payments can be reconciled with the original data, which can also be presented.

In CENV result display step 260, the invention presents the results of the application of the CENV Defense, which include for both the Preference Payments protected by the CENV Defense and the Preference Payments not protected by the CENV Defense, Invoice Number 111, Invoice Amount 112, Provided Date 113, Payment Date 114 and Payment Time 115 in an easily readable format that may also be printed onto paper media.

Calculation of Average Payment Times Within and Prior to Preference Period

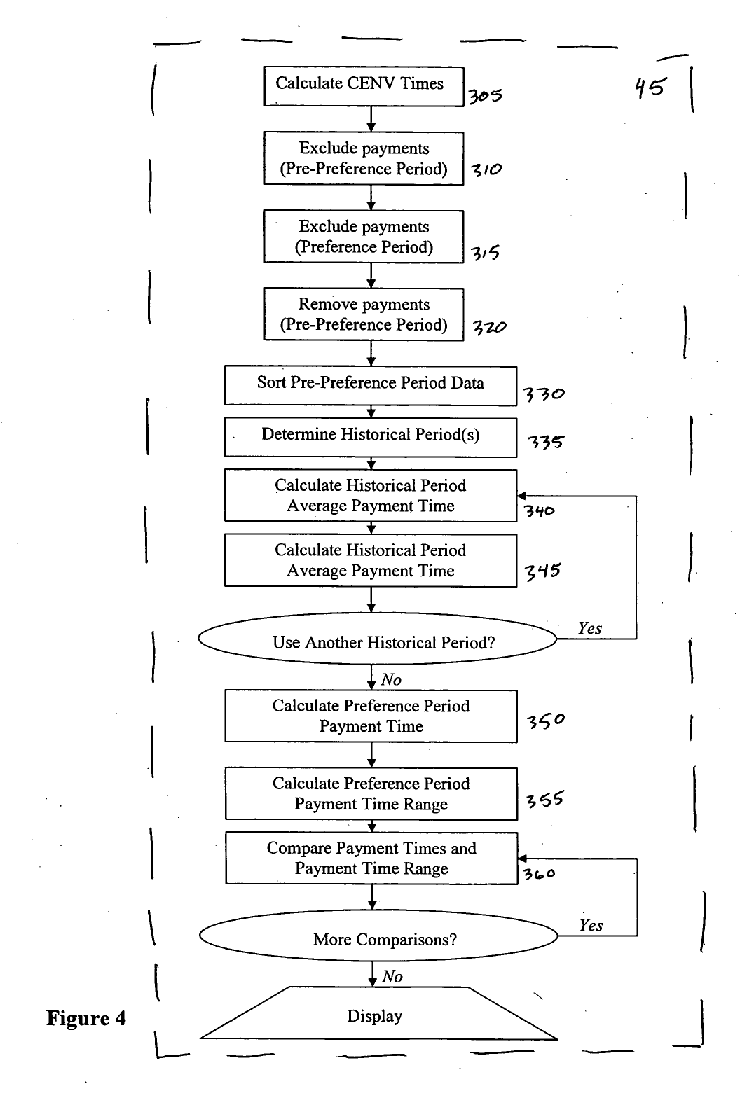

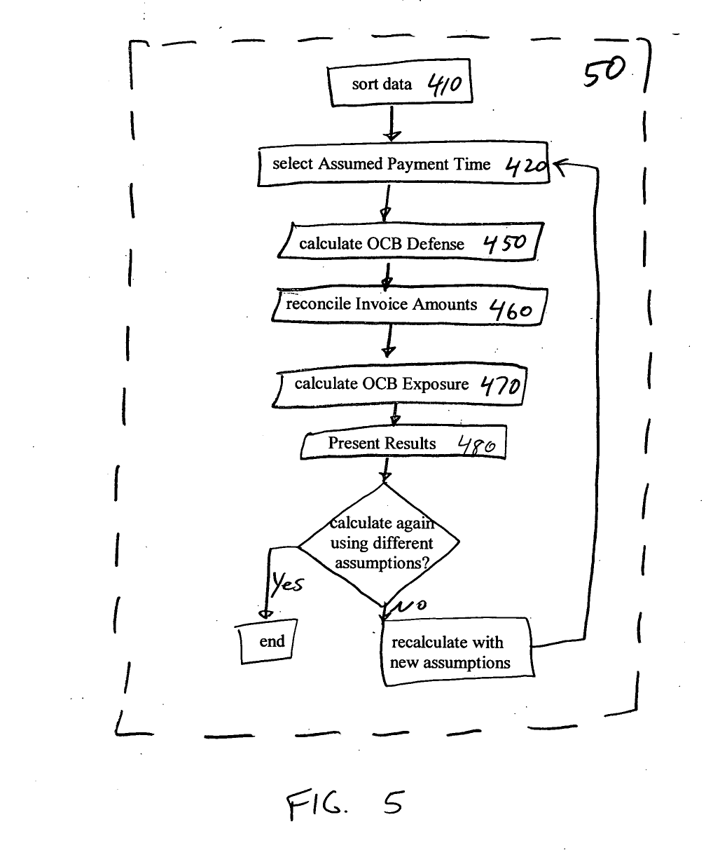

FIG. 4 depicts a block diagram illustrating a preferred embodiment for the step of calculating average payment times 45, including calculating Average Payment Times 303 and Payment Time Ranges 302 for the Pre-Preference and Preference Periods of FIG. 1, assuming no Payment Time has been calculated in the preliminary manipulations of original data.

In Payment Time calculation step 305, for the Pre-Preference Period data, if it exists, and the Preference Period data, for each Payment Date 114, a Payment Time 116 is calculated.

In payment exclusion step 310, for the Pre-Preference Period data, for those payments known to have been made outside the OCB because their Payment Times 116 are too low or too high to be considered to have been paid within the OCB, such Payment Times 116 and related Lines of Data 102 (Invoice Date 111, Invoice Amount 112, Provided Date 113, Payment Date 114 and Payment Time 116) are removed. Although any method of removal maybe used, it is contemplated that such removal may be executed manually by the Recipient. It is also contemplated that such removal may be performed by defining a lower boundary of Payment Time 116 such that payments made in fewer days than the lower boundary are considered to have been paid outside the OCB, and by defining an upper boundary of Payment Time 116 such that payments made in more days than the upper boundary are considered to have been paid outside the OCB, inputting the lower and upper boundaries of Payment Times into the invention which will remove from the Pre-Preference Period data that data corresponding to those payments made outside the OCB.

In exception step 315, for those Provided Dates 113 within the Pre-Preference Period representing goods or services for which no payment was received, those Provided Dates 113 and related Lines of Data 102 (Invoice Date 111, Invoice Amount 112, Provided Date 113, Payment Date 114 and Payment Time 116) are removed from the Pre-Preference Period data. This may be done manually or by the invention, using spreadsheet or database functions as are known in the art.

In Pre-Preference removal step 320, for those payments made within the Pre-Preference Period and known to have been made outside the OCB because the manner and/or method by which the payment was made was not within the OCB, those payments and related Lines of Data 102 (Invoice Date 111, Invoice Amount 112, Provided Date 113, Payment Date 114 and Payment Time 116) are removed. For example, if the Recipient typically received payment from the Debtor by check by mail and the Debtor made one payment in cash by personal delivery, such payment may be deemed to be made outside the OCB. Although any method of removal of payments may be used, it is contemplated that such removal may be executed manually by the Recipient. It is also contemplated that the invention can prepare the Pre-Preference Period data such that the Recipient can easily specify, by, in step 120 or other appropriate step, making a check or placing some sort of other indicator in a column next to any Line of Data 102 or by any other method, which payments and related data should be removed because the payments were not made in the OCB, and the invention will remove the data related to such payments.

In Pre-Preference sorting step 330, the invention sorts the remaining Pre-Preference Period data by Payment Date in ascending chronological order. Separate operations are performed on the Pre-Preference Period data and the Preference Period Data.

In historical period determination step 335, if Pre-Preference Period data exists, one or more Historical Periods shall be determined. Although any method of determining this Historical Period or Periods may be used, the Recipient can specify any time period from the day prior to the first date of the Preference Period backward in time any number of days, months or years. Typically, periods of nine months, one year, eighteen months or two years prior to the Preference Period are used, but some Recipients do not have such lengthy or applicable history. Alternatively, the invention itself may determine the one or more Historical Periods based on pre-determined formulas for typically used Historical Periods as are known in the art.

In Historical Period Average Payment Time calculation step 340, for each Historical Period, the invention calculates the Average Payment Time 303 by adding the Payment Times 116 for each Historical Period and dividing by the number of Payment Times 116. If this result is not an integer, the number may be rounded to the nearest integer.

In Historical Period Payment Time Range calculation step 345, for each Historical Period, the invention determines the Payment Time Range 302. Although any method may be used, this can be done by sorting the Historical Period data by Payment Time 116 in chronological order, in which case the first Payment Time 116 in the list of data will be the low end of the Payment Time Range 302 and the last Payment Time 116 in the list will be the high end of the Payment Time Range 302.

In Preference Period Average Payment time calculation step 350, for the Preference Period, the invention calculates the Average Payment Time 303 by adding the Payment Times 116 for the Preference Period and dividing by the number of Payment Times 116. If this result is not an integer, the number may be rounded to the nearest integer.

In Preference Period Payment Time Range Calculation step 355, for the Preference Period, a Payment Time Range 302 is determined. Although any method may be used, this can be done by sorting the Preference Period data by Payment Time 116 in chronological order, in which case the first Payment Time 116 in the list of data will be the low end of the Payment Time Range 302 and the last Payment Time 116 in the list will be the high end of the Payment Time Range 302.

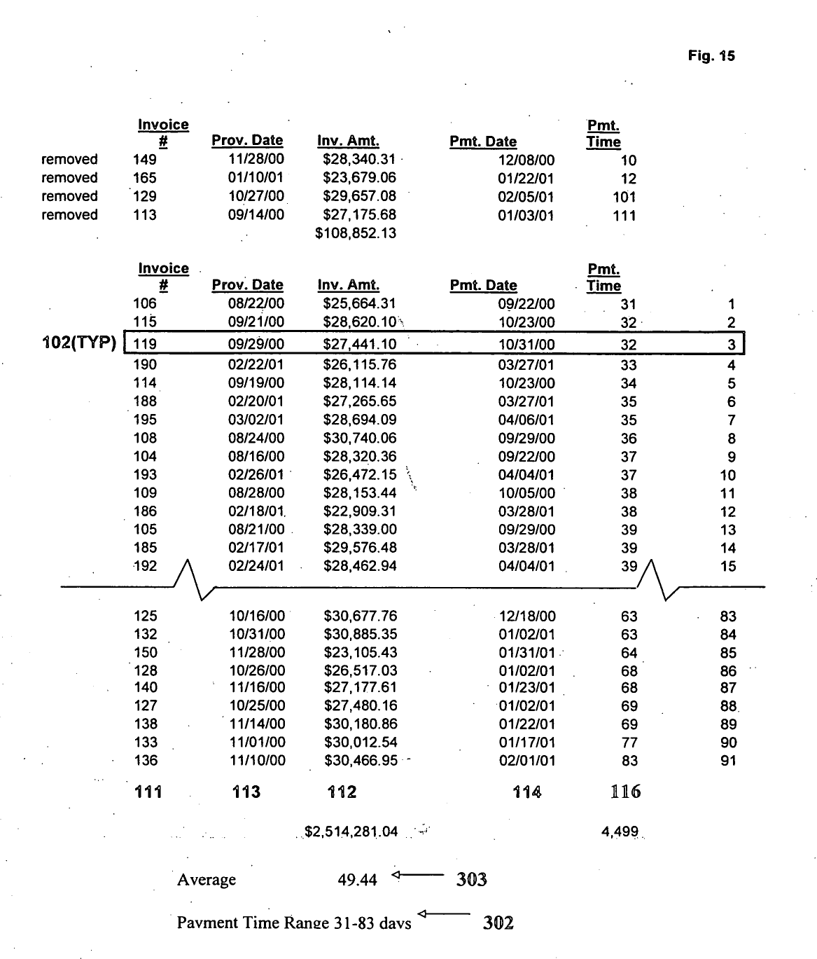

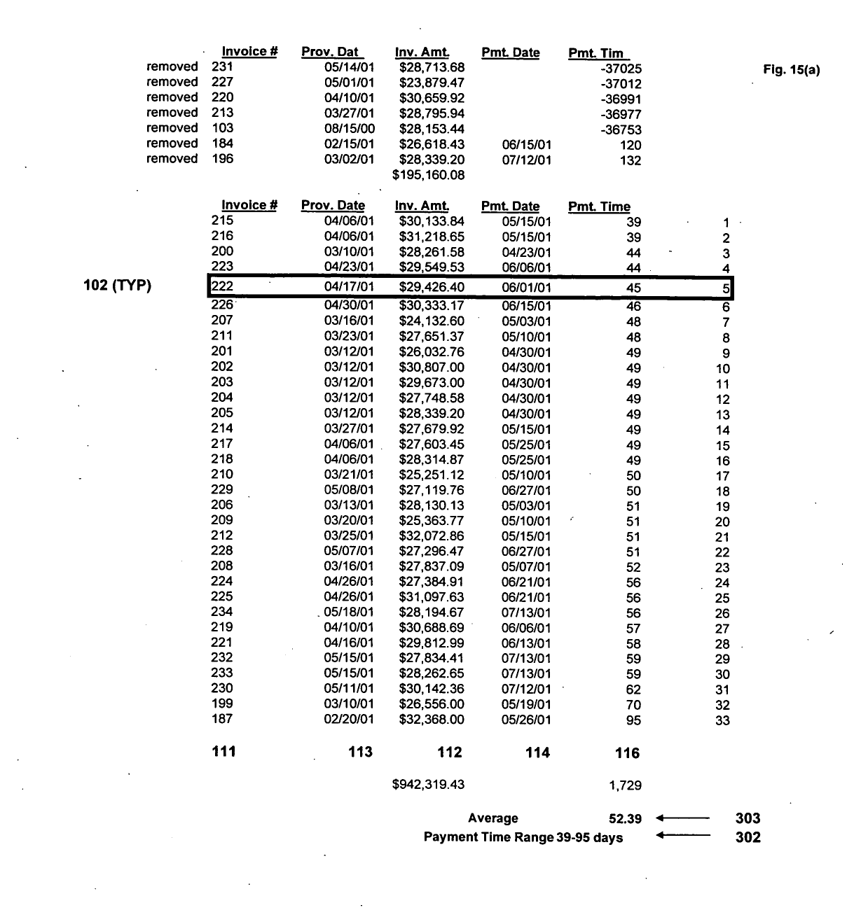

Samples of the output of the data after the above calculations and manipulations using sample actual values for the Pre-Preference Period and Preference Period, respectively, are shown at FIGS. 15 and 15(a). In these figures the Preference Period data is sorted by Payment Date 114, the limits of which (after removing outliers) indicate the Payment Time Range 302.

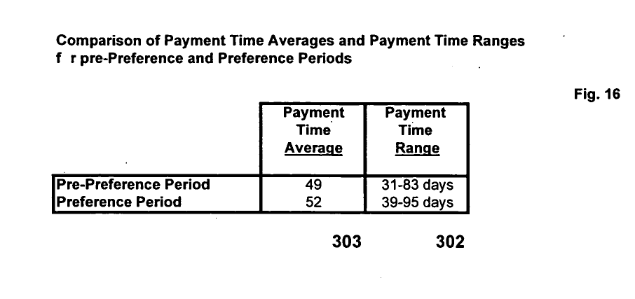

In payment time and range comparison step 360, as an indication as to how the Payment Times 116 of the Historical Period(s) correlate to the Preference Period Payment Times 116, the Average Payment Time 303 and Payment Time Range 302 for the Preference Period may be compared to the Average Payment Time 303 and Payment Time Range 302 for each Historical Period. A sample of such comparison is shown at FIG. 16.

In Historical Period data display step, it is contemplated that the invention will display, for each Historical Period, the Pre-Preference Period data separated into the Historical Period data and data not falling within the Historical Period. For each Historical Period, the resulting two sets of data will be sorted in an easily understandable format such as each line of data being sorted by Provided Date or Invoice Date or in any other format that displays the appropriate data in an understandable format as is known in the art. The dollar amounts of the payments in the two Historical Period data sets will be summed separately, then added together, then added to the amounts of the Preference Payments so that they may be reconciled with the payments from the original data provided.

Calculation of Ordinary Course of Business Defense

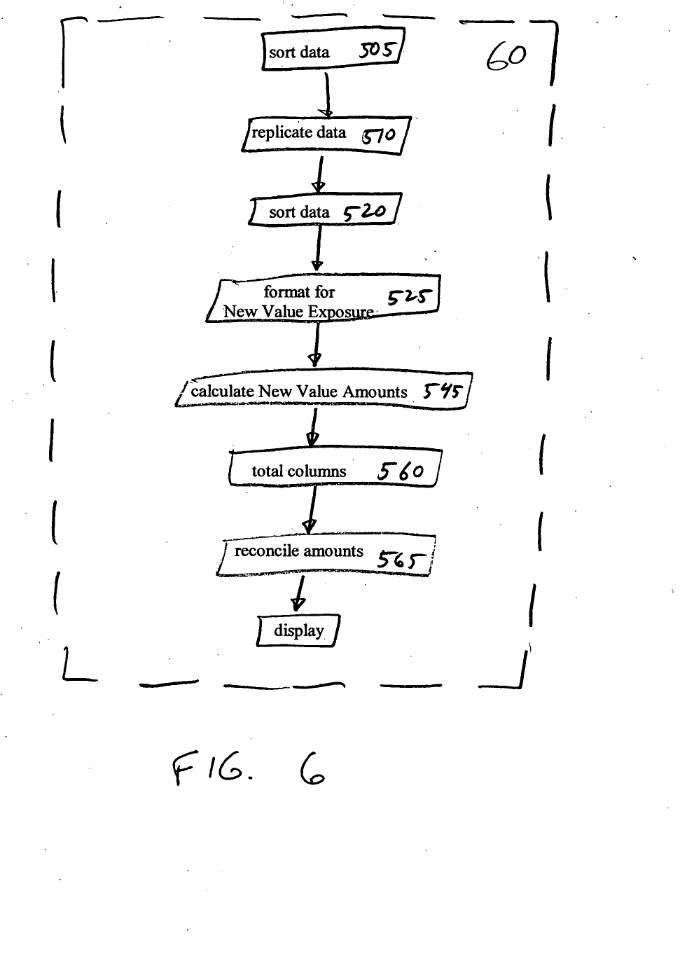

FIG. 5 depicts a block diagram illustrating a preferred embodiment for the process of calculating the OCB Defense 50 of FIG. 1.

In OCB data sorting step 410, the Preference Period Data is sorted by Payment Time 116 in ascending chronological order. For this analysis, Preference Period Data includes data related to all Preference Payments, including those removed from the data to determine the Payment Time Range 302 and to calculate the Average Payment Time 303 within the Preference Period.

In OCB payment time selection step 420, the Assumed Payment Time, which may be one of the Historical Average Payment Times 303, is used as the middle of OCB Protected Range. Building on the data set created in data preparation step 20, a number of new columns, such as twelve, are created following the existing five columns of data. The first added column displays those Preference Payments protected by the OCB if no OCB Defense applies. Accordingly, in the first added column, no OCB Protected Range applies, and none of the Preference Payments will be shown to be protected in the first added column.

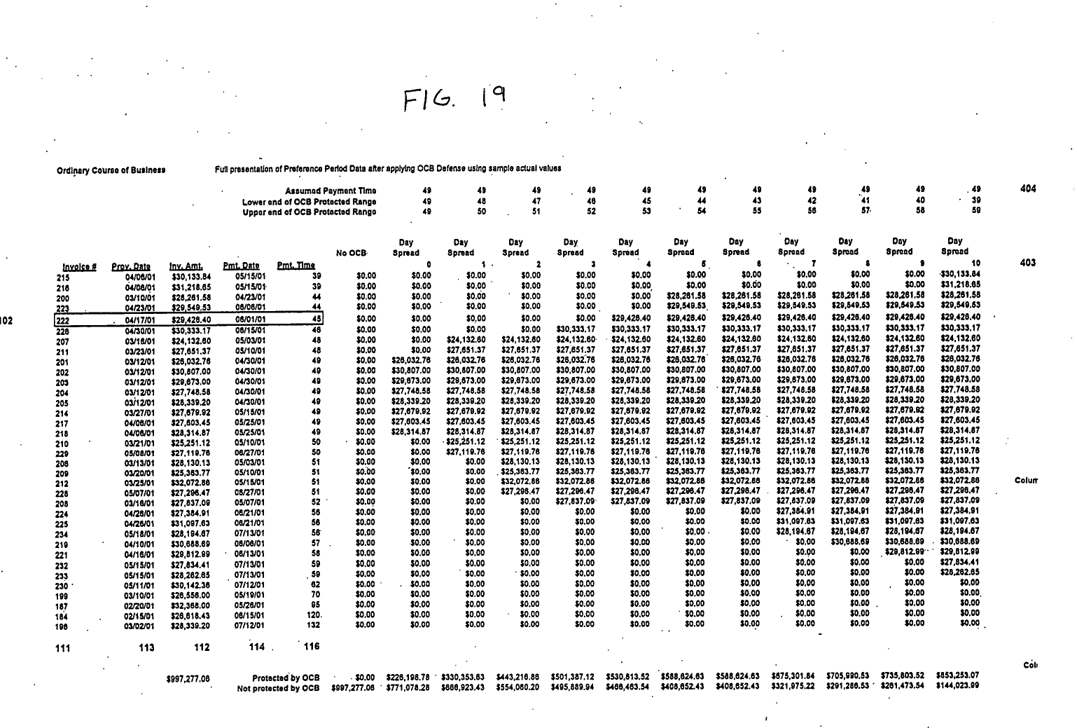

In OCB defense calculation step 450, the subsequent added columns display those Preference Payments protected by the OCB Defense if the Day Spread 403 is any number of pre-set or chosen integers, such as 0, 1, 2 or 3. It is contemplated that the other eleven added columns will show the Preference Payments protected by OCB Protected Ranges with Day Spreads 403 from 0 through 10 in ascending order so that the data can be easily visualized and understood. To calculate the Preference Payments protected by the OCB Defense, for each added column, the invention indicates the Assumed Payment Time 404, indicates the Day Spread 403, subtracts from the Assumed Payment Time 404 the Day Spread 403 and shows the result as the lower end of the OCB Protected Range, and adds to the Assumed Payment Time 404 the Day Spread 403 and shows the result as the upper end of the OCB Protected Range. For each Preference Payment, the Payment Time 116 is compared to the lower end of the OCB Protected Range and the upper end of the OCB Protected Range and if the Preference Payment is not less than the lower end of the OCB Protected Range and is not greater than the upper end of the OCB Protected Range, the amount of the Preference Payment is copied in that column on that Line of Data 102 corresponding to that Preference Payment. If the Payment Time 116 is less than the lower end of the OCB Protected Range or greater than the upper end of the OCB Protected Range, then 0 is entered in that column on that Line of Data 102 corresponding to that Preference Payment. For example, referring to FIG. 19 and using the assumption that twelve columns are added to the existing Preference Period data, the Assumed Payment Time 404 is 49, and the Day Spreads 403 are 0, 1, 2, 3, 4, 5, 6, 7, 8, 9, and 10, in the fourth added column, the Day Spread would be 2, the lower end of the OCB Protected Range would be 47, the upper end of the OCB Protected Range would be 51, and the Protected Range would be the 5 days from 47-51 days. The value of those Preference Payments with Payment Times 116 from 47 to 51 days will be copied into that fourth added column and verified by reviewing the Payment Times of those values copied into each column.

In OCB reconciliation step 460, the amounts in the original Invoice Amount 112 column are summed so that they can be reconciled with the previous data set.

In OCB exposure calculation step 470, the zero values input and the Invoice Amounts 112 copied into each of the added columns are summed so that the total of the values in any column indicates the amount of Preference Period Payments protected by the OCB Defense given the Assumed Payment Time and OCB Protected Range corresponding to that column. Each total amount of Preference Payments protected by the OCB Defense is subtracted from the total Invoice Amount 112, the result of which indicates the amount of Preference Period Payments not protected by the OCB Defense, which also equals the Recipient's Exposure after the OCB Defense is applied.

In OCB result presentation step 480, the results are displayed in an easily readable and understandable manner according to the display capabilities of the source or otherwise known in the art. Because the Preference Period data is sorted in ascending Payment Time 116 order, the resulting chart of FIG. 19 visually demonstrates how each integral increase in Day Spread 403 affects the amount of Preference Payments protected by the OCB Defense.

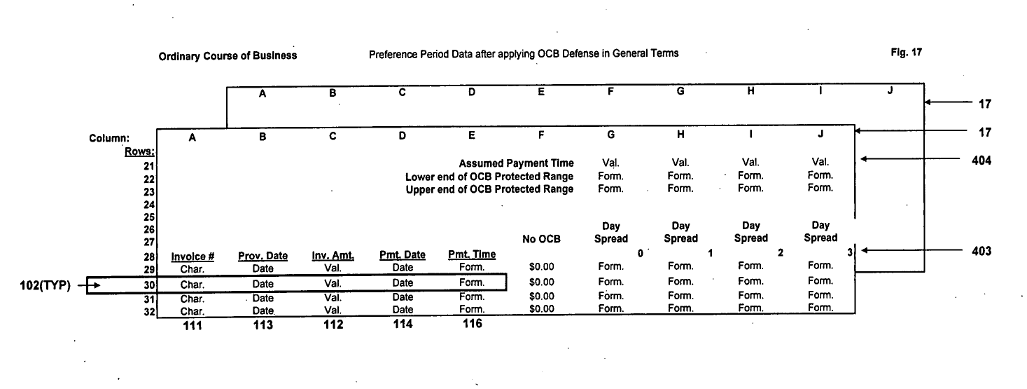

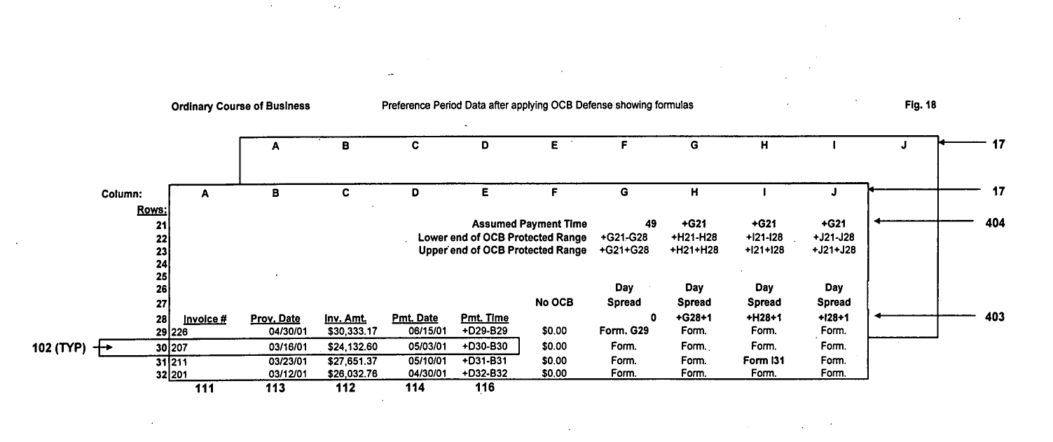

In OCB recalculation step, the OCB Defense may be recalculated using another Assumed Payment Time 404. It is contemplated that the OCB Defense will be recalculated using a spread of Assumed Payment Times 404 of five days above and below the originally chosen Assumed Payment Time 404. For example, if the originally chosen Assumed Payment Time 404 was 46, the OCB Defense would be recalculated using Assumed Payment Times 404 of 41, 42, 43, 44, 45, 47, 48, 49, 50, and 51. It is further contemplated that this range of Assumed Payment Times 404 will include the Historical Average Payment Times 303 for all Historical Periods so that results will be provided for all Historical Average Payment Times 303. As seen above, each of the Assumed Payment Times 404 (and the column where no Assumed Payment Time 404 is used) will produce 12 results ranging from no OCB protection to protecting a range with a Day Spread 403 up to 10 days, or an OCB Protected Range of 21 days. Accordingly, while any number of Assumed Payment Times 404 and Day Spreads 403 may be calculated, it is contemplated that at least 132 results will be provided. A depiction of a preferred format for the presentation of Preference Period Data after applying the OCB Defense in general terms is shown at FIG. 17. At column G of FIG. 17 a preferred formula for comparing the Payment Time for the Line of Data represented in line 29 to the lower and upper ends of the OCB Protected Range is assuming an Assumed Payment Time of that value at G21 plus and minus the Day Spread at G28 is G29: =IF(+$E29>=G$22,IF($E29<=G$23,$C29,0),0. In column I of FIG. 17, a preferred formula for comparing the Payment Time for the Line of Data represented in line 31 to the lower and upper ends of the OCB Protected Range is assuming an Assumed Payment Time of that value at I21 plus and minus the Day Spread at I28 is I31: =IF(+$E31>=I$22,IF($E31<=I$23,$C31,0),0). It is contemplated that any spreadsheet based formula (described here or elsewhere in this description of the invention) may be modified to take advantage of absolute cell references. A depiction of a presentation of Preference Period Data after applying the OCB Defense displaying formulas is shown at FIG. 18. A depiction of a display of Preference Period Data after applying the OCB Defense according to the OCB result presentation step 480 is shown at FIG. 19.

Calculate the Subsequent New Value Defense

FIG. 6 depicts a block diagram illustrating a preferred method for the process of calculating the Subsequent New Value Defense 60 of FIG. 1.

In SNV data sorting step 505, using the Preference Period data of Invoice Number 111, Invoice Amount 112, Provided Date 113 and Payment Date 114, sorted by Payment Date 114 in ascending order and including those Lines of Data 102 that represent goods and services provided within the Preference Period but were not paid, the invention creates a new column and numbers each Line of Data 102 in ascending order with a Reference Number 511. The Reference Numbers 109 relating to each Preference Payment should be italicized or otherwise distinguishable from the other data for easy reference. This allows a Recipient to track the data related to any Invoice Number 111 by using the Reference Number 109, not the cumbersome Invoice Number 111, which may be difficult to visually distinguish from other Invoice Numbers 111.

While any method of calculating the SNV Defense may be used, it is contemplated that the following steps will be used for such calculation.

In the SNV data replication step 510, the user copies the above Lines of Data 102 and replicates the data below the original data. Those Lines of Data 102 that represent goods and services provided within the Preference Period but were not paid are removed from the original (non-replicated) data because they were not Preference Payments because the Debtor never paid for those goods or services. The replicated data should be bolded or otherwise distinguishable from the original data for easy reference. The replicated data is reorganized so that the replicated Provided Date (the New Value Provided Date) is lined up in the same column as the original data Payment Date 114 and the other columns of data are placed into three newly created columns following the existing five columns labeled New Value Reference Number 503, New Value Invoice Number 511 and New Value Invoice Amount 512.

In the SNV data sorting step 520, all existing rows of data are then sorted by the original Payment Date 114/New Value Provided Date column in ascending order so that the New Value Provided Dates and related data (which are bolded) are inserted chronologically into the chronological Payment Dates 114. New Value Provided Dates are placed after Payment Dates 114 if such dates are the same, although other assumptions as to which occurred first if both occurred on the same day may be made.

In the SNV format step 525, four additional columns are added to the data set. A ninth column, a New Value Available 516 column, is added to the right of all existing columns that, for each Line of replicated Data 102, and the amount of new value provided (which for each Line of Data 102 is the amount from Invoice Amount 112 column) is copied into that ninth column. An tenth column, the New Value Used 517 column, is added that indicates what portion, if any, of the New Value Available 516 can be used by the Recipient to decrease the Recipient's Exposure.

An eleventh column, the New Value Not Used 518 column, is added which indicates what portion, if any, of the New Value Available 516 cannot be used by the Recipient to decrease the Recipient's Exposure.

A twelfth column, the Exposure After New Value column, is added which indicates the Recipient's Exposure after the SNV Defense is applied.

In the SNV calculation step 545, the values of the final three columns added in the SNV format step 525 are calculated from certain alogrithms. To calculate the values in the New Value Used column, the New Value Available 516 for any Line of Data 102 (x) is compared to the Exposure in the prior Line of data 102 (x-1). If there is no Exposure on line x-1, 0 is inserted in the New Value Used 517 column on Line x. If Exposure exists on Line x-1, to the extent that the New Value Available 516 on line x does not exceed the Exposure on line x-1, the entire amount of New Value Available 516 is copied and inserted in the New Value Used 517 column on Line x. If Exposure exists on Line x-1 that does not exceed the New Value Available 516 on Line x, then the Exposure on Line x-1 will be inserted in the New Value Used 517 column on Line x. The formula in the first line of this column should be checked to make sure its reference to a previous line does not provide inaccurate results for the first line of calculations.

To calculate the values in the New Value Not Used Column 518, for any Line of Data 102, the New Value Used 517 is subtracted from the New Value Available 516.

To calculate the values in the Exposure column for any Line of Data 102 x, the Exposure on Line x-1 is added to the Invoice Amount 112 in the fourth column on Line x, and from this sum, the New Value Used 517 amount for Line x is subtracted. The formula in the first line of this column should be checked to make sure its reference to a previous line does not provide inaccurate results for the first line of calculations.

In the SNV Defense totalization step 560, the values in the Invoice Amount 112 in the fourth column, the New Value Available 516 column, the New Value Used 517 column and the New Value Not Used 518 Column are added at the bottom of each of those four columns to demonstrate the affect of applying the SNV Defense and the Recipient's Exposure to the Claim after applying the SNV Defense.

In the SNV reconciliation step 565, the totals of the New Value Used 517 column and the New Value Not Used 518 column are added together to demonstrate that the sum reconciles with the total of the New Value Available 516 column. The totals of the New Value Used 517 column and the Exposure column are added together to demonstrate that the sum reconciles with the total of the Amount of Preference Payments Received column.

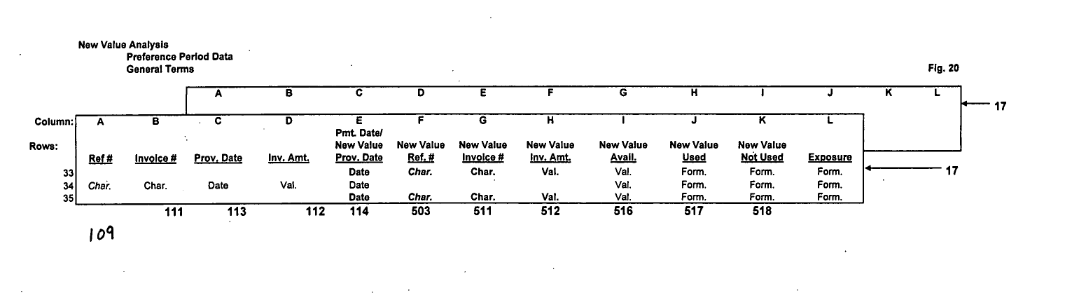

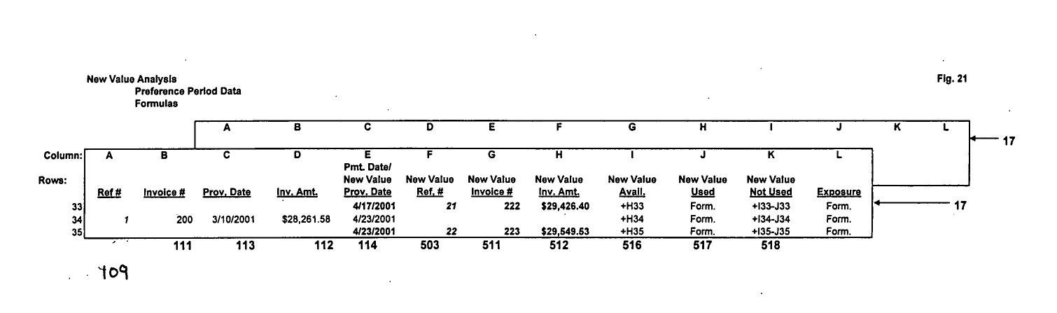

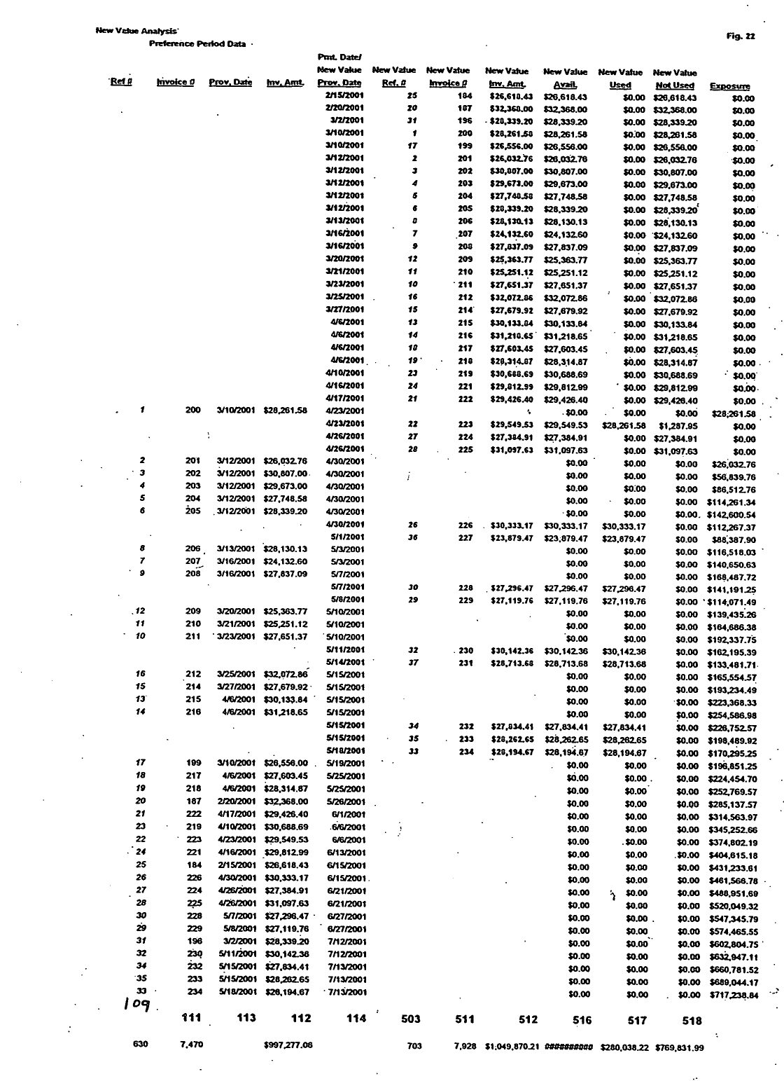

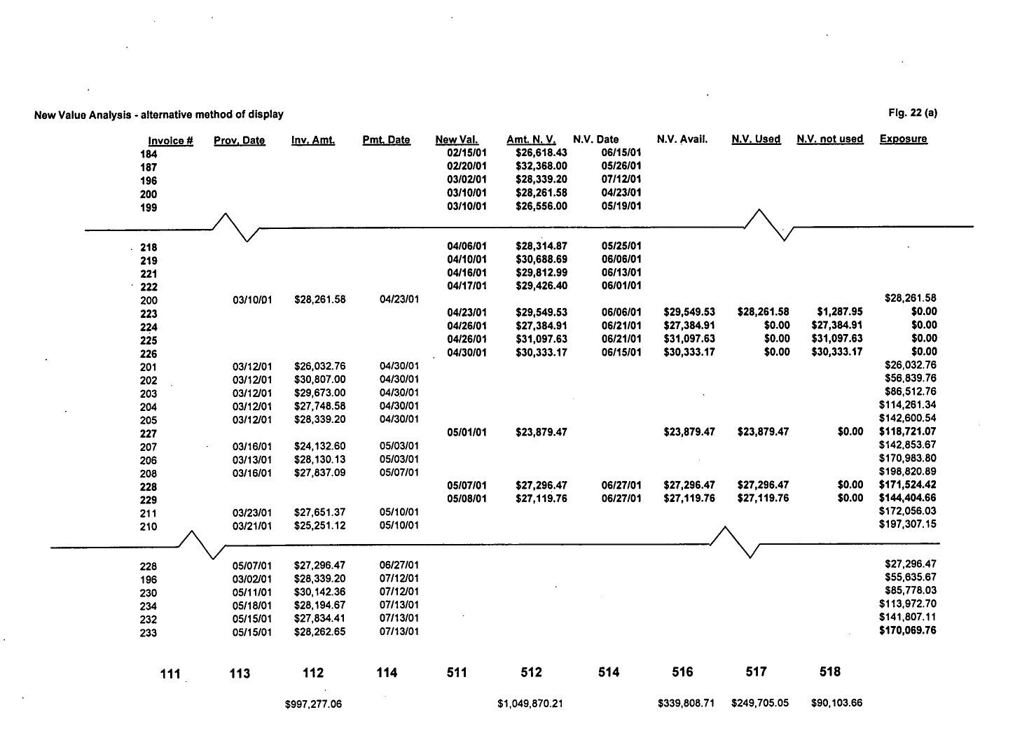

A depiction of a presentation of Preference Period Data after applying the SNV Defense in general terms in shown at FIG. 20. Reference Number 109 may be an alpha/numeric character to represent a reference number related to any particular Invoice Number 111 or Preference Payment. Invoice Number 111 may be an alpha/numeric character to represent an Invoice Number. Provided Date 113 may be a date in any known date format. Invoice Amount 112 may be a value in any known value format, preferably a currency format. Original Data Payment Date/Replicated Data Provided Date 114 may be a date in any known date format. New Value Reference Number 503 may be an alpha/numeric character to represent a reference number related to any particular invoice or Preference Payment. New Value Invoice Number 511 may be an alpha/numeric character to represent an Invoice Number. New Value Invoice Amount 512 may be a value in any known value format, preferably a currency format. New Value Available 516 requires the same value as in the cell in the column to its left (Column H in FIG. 20) (or zero if there is no value in that cell). New Value Used 517 requires the result of a formula where if New Value Available 516 is greater than the Exposure on the previous line, then input the Exposure from the previous line, otherwise, input the value of the New Value Available 516. New Value Not Used 518 requires the result of a formula that subtracts New Value Used 517 from New Value Available 516. Exposure requires the result of a formula that adds the Original Data Invoice Amount 112 (the amount in Column D of FIG. 20) to the Exposure from the previous line, and subtract from that sum the New Value Used. A depiction of a presentation of Preference Period Data after applying the SNV Defense is shown at FIG. 21 in a spreadsheet format that describes the relationships between the assigned rows and columns used, to calculate the resulting Exposure. For the algorithms of FIG. 21, New Value Used 517 requires the result of a formula where if New Value Available is greater than the Exposure on the previous line, then input the Exposure from the previous line, otherwise, input the value of the New Value Available. For example,
=IF(I33>L32,L32,I33) Formula J33:
=IF(I34>L33,L33,I34) Formula J34:
=IF(I35>L34,L34,I35) Formula J35:

New Value Not Used 518 requires the result of a formula that subtracts New Value Used from New Value Available. For example, K33=+I33−J33. Exposure requires the result of a formula that adds the Original Data Invoice Amount (the amount in column D) to the Exposure from the previous line, and subtract from that sum the New Value Used. For example, Formula L33: +L32+D33−J33. FIG. 22 provides a depiction of a presentation of Preference Period Data and Exposure after applying the SNV Defenses using sample actual values.

FIG. 22(a) provides a depiction of an alternative method of presenting Preference Period Data after applying the SNV Defense using sample values where no Reference Numbers 109 are shown. The Invoice Numbers 111 related to the Preference Payment Payment Dates 114 and the New Value Provided Dates are shown in the same column. The Preference Payment Payment Dates 114 and the New Value Provided Dates are shown in separate columns, and New Value Available 516 is not shown until after the date the first Preference Payment was made. For illustrative purposes, in FIG. 22(a), the New Value represented by Invoice Number 226 and provided on Apr. 30, 2001 is shown to have occurred prior to the Preference Payment being made on Apr. 30, 2001 (note that this is an alternative to the preferred method of placing the New Value Provided Date prior to Preference Payment Payment Date if both occur on the same day).

Combine and Calculate the Ordinary Course of Business and Subsequent New Value Defenses

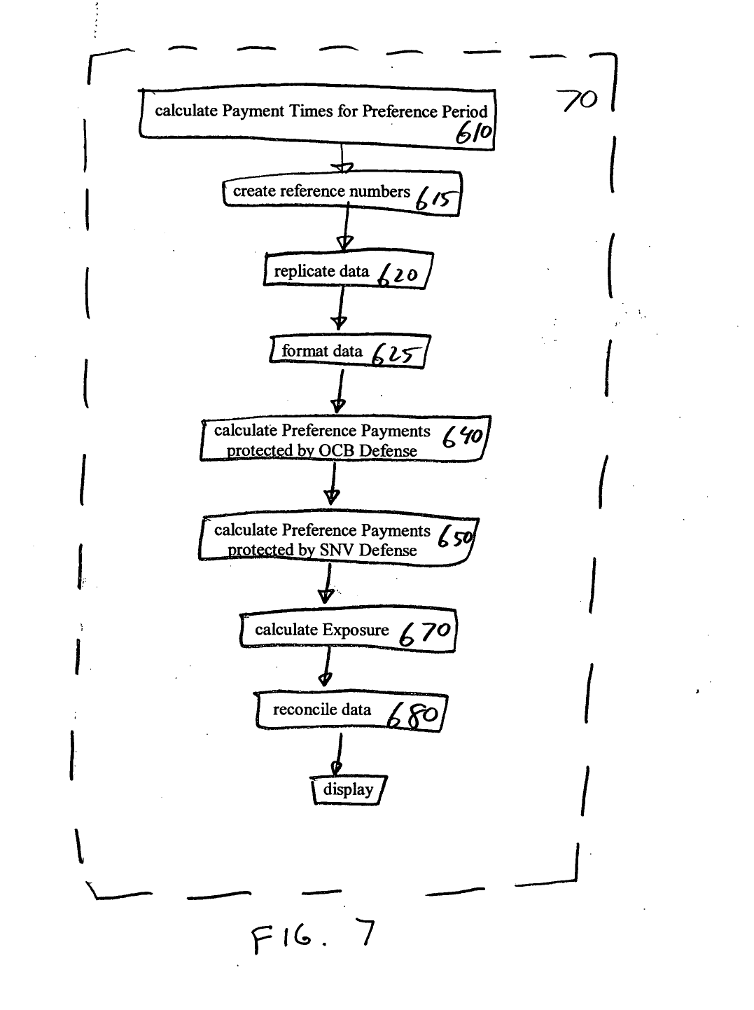

FIG. 7 depicts a block diagram illustrating a preferred embodiment for the process of calculating the application of both the OCB and SNV Defenses 70 of FIG. 1.

Combined OCB/SNV Payment Time calculation step 610 uses the Preference Period Data columns of Reference Number 109 (assuming Reference Number already created), Invoice Number 111, Provided Date 113, Invoice Amount 112 and Payment Date 114, sorted by Payment Date 114 in ascending chronological order and including those Lines of Data that represent goods and services provided within the Preference Period but never paid for. If not already calculated, the Payment Times 116 for each Line of Data 102 are calculated and included in a column to the right of the existing five columns.

In OCB/SNV Reference Numbering step 615, if not already done, a new column is created and numbers each Line of Data 102 with a Reference Number 109 in ascending order. The Reference Numbers 109 maybe italicized or otherwise distinguishable from the other data for easy reference. This allows a Recipient to track the data related to any Invoice Number 111 by using the Reference Number 109, not the cumbersome Invoice Number 111, which may be difficult to visually distinguish from other Invoice Numbers 111. While any method of calculating and combining the OCB and SNV Defenses may be used, it is contemplated that the following steps will be used for such calculation.

In OCB/SNV data replication step 620, the Preference Period data is copied and replicated below the original data. Those Lines of Data 102 that represent goods and services provided within the Preference Period but not paid are removed from the original (non-replicated) data because they were not Preference Payments because the Debtor never paid for those goods or services. The replicated data may be bolded or otherwise distinguishable from the original data for easy reference.

In OCB/SNV data formatting step 625, the replicated data is reorganized so that the replicated New Value Provided Date is lined up in the same column as the original Payment Date 114 and the other columns of replicated data are named New Value Reference Number, New Value Invoice Number, New Value Invoice Amount, New Value Payment Date and New Value Payment Time, and are placed into five newly created columns following the existing six columns. All existing columns of data are then sorted by the original Payment Date 114/New Value Provided Date column in ascending order so that the New Value Provided Dates are inserted chronologically into the chronological Payment Dates 114, and New Value Provided Dates are placed after Payment Dates 114 if such dates are the same. A new column, the Protected by Ordinary Course of Business 611 column, is added after the replicated New Value Payment Time 116 column, which will indicate the value of each Preference Payment that is protected by the OCB Defense.

In OCB protection step 640, for each Assumed Payment Time 404 and Day Spread 403 used in the calculation of the OCB Defense, which as noted above may be 132 different scenarios or more or less, the lower end and the upper end of the OCB Protected Range is determined. The Assumed Payment Time 404, Day Spread 403, lower end of the OCB Protected Range and upper end of the OCB Protected Range are displayed above the title of the added Protected by OCB Defense 611 column or at any other appropriate location. For each Line of Data 102, the Payment Time 116 is compared to the lower end of the OCB Protected Range and the upper end of the OCB Protected Range, and if the Payment Time 116 is not less than the lower end of the OCB Protected Range and is not greater than the upper end of the OCB Protected Range, the Invoice Amount 112 related to that Preference Payment is copied to the Protected by OCB Defense 611 column. If the Payment Time 116 is less than the lower end of the OCB Protected Range or greater than the upper end of the OCB Protected Range, then 0 is entered in the Protected by Ordinary Course of Business 611 column.

In SNV protection step 650, four columns, New Value Available 516, New Value Used 517, New Value Not Used 518, and Exposure after OCB and SNV Defenses Applied are added to the right of the existing columns. To calculate the values in the New Value Available 516 column, for each replicated Line of Data 102, the New Value Payment Time 616 is compared to the lower end of the OCB Protected Range and the upper end of the OCB Protected Range and if the New Value Payment Time 616 is less than the lower end of the OCB Protected Range or is greater than the upper end of the OCB Protected Range, the New Value Invoice Amount 512 is copied into the New Value Available 516 Column. If the New Value Payment Time 616 is not less than the lower end of the OCB Protected Range or greater than the upper end of the OCB Protected Range, then 0 is entered in the New Value Available 516 Column. For example, if the Assumed Payment Time 404 is 50 days and the Day Spread 403 is 5, the OCB Protected Range will be from 45 to 55 days, a New Value Payment Time 616 of 57 days would not be protected by the OCB Defense, the Preference Payment related to that New Value Payment Time 616 of 57 days may be subject to the SNV Defense, and the related New Value Invoice Amount 512 would be inserted into the New Value Available 516 column.

To calculate the values in the New Value Used 517 column, the New Value Available 516 for any Line of Data 102 (x) is compared to the Exposure in the prior Line of Data 102 (x-1). To the extent that the New Value Available 516 on line x does not exceed the Exposure on line x-1, the entire amount of New Value Available 516 is copied and inserted in the New Value Used 517 column on Line x. If Exposure exists on Line x-1 that does not exceed the New Value Available 516 on Line x, then the Exposure on Line x-1 will be inserted in the New Value Used 517 column on Line x. Thus, if the Exposure on Line x-1 equals 0, 0 is inserted in the New Value Used 517 column on Line x.

To calculate the values in the New Value Not Used Column 518, for any Line of Data 102, the New Value Used 517 is subtracted from the New Value Available 516.

In the combined OCB/SNV analysis step 670, to calculate the values in the Exposure column for any Line of Data 102 x, add the Exposure on Line x-1 to the Invoice Amount 112 in the fourth column on Line x, and from this sum subtract the Protected by Ordinary Course of Business amount on Line x and subtract the New Value Used amount on Line x. Add the values in each of the separate columns titled Invoice Amount, the Protected by Ordinary Course of Business 611, New Value Available 516, New Value Used 517 and the New Value Not Used 518 and display the total at the bottom of each column so that the Recipient will understand the affect of applying the OCB and SNV Defenses together and will know the Recipient's Exposure to the Claim after applying these Defenses.

In the OCB/SNV reconciliation step 680, add totals of the New Value Used 517 column and the New Value Not Used 518 Column and reconcile that sum to the total of the New Value Available 516 column. Add totals of the Protected by Ordinary Course of Business 611, New Value Used 517, and Exposure columns and reconcile the sum to the total of the Invoice Amount 112 column.

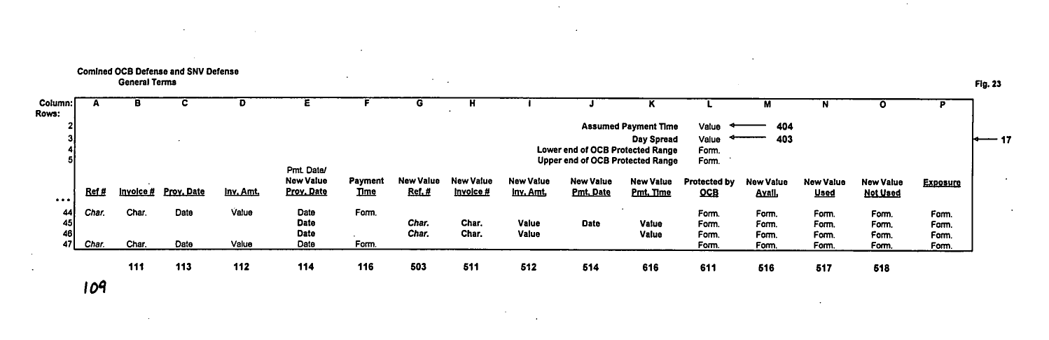

A depiction of a presentation of Preference Period Data after combining and applying the OCB and SNV Defenses in general terms is shown at FIG. 23. Assumed Payment Time 404 may be any numeric character (may be imported from other part of spreadsheet calculated by the invention, or manually inserted). Day Spread 403 may be any numeric character (may be imported from other part of spreadsheet calculated by the invention, or manually inserted). Lower End of OCB may be numeric character resulting from subtracting Day Spread from Assumed Payment Time. Upper End of OCB may be numeric character resulting from adding Day Spread to Assumed Payment Time. Reference Number 109 may be an alpha/numeric character to represent a reference number related to any particular invoice or Preference Payment. Invoice Number 111 may be an alpha/numeric character to represent an Invoice Number. Provided Date 113 may be a date in any known date format. Invoice Amount 112 may be a value in any known value format, preferably a currency format. Original Data Payment Date/New Value Provided Date 114 may be a date in any known date format that represents the Payment Date of Preference Payments (unbolded) or the Provided Date of all goods or services provided within the Preference Period (bolded). Payment Time 116 requires the result of a formula subtracting Provided Date from Payment Date and displaying the result in numeric form, preferably as an integer. New Value Reference Number may be an alpha/numeric character to represent a reference number related to any particular invoice or Preference Payment. New Value Invoice-Number 511 may be an alpha/numeric character to represent an Invoice Number. New Value Invoice Amount 512 may be a value in any known value format, preferably a currency format. New Value Payment Date 514 may be a date in any known date format that represents the Payment Date of Preference Payments. New Value Payment Time 616 requires the result of a formula subtracting new Value Provided Date from New Value Payment Date and displaying the result in numeric form, preferably as an integer. Protected by OCB 611 requires the result of a formula comparing the Payment Date with the Upper and Lower Ends of the OCB Protected Range and inputting the Invoice Amount if the Payment Time falls within the OCB Protected Range and inputting zero if the Payment Time falls outside the OCB Protected Range. New Value Available 516 requires the result of a formula comparing the New Value Payment Date with the Upper and Lower Ends of the OCB Protected Range and inputting the New Value Invoice Amount if the new Value Payment Time falls within the OCB Protected Range and inputting zero if the New Value Payment Time falls outside the OCB Protected Range. New Value Used 517 requires the result of a formula where if New Value Available is greater than the Exposure on the previous line, then input the Exposure from the previous line, otherwise, input the value of the New Value Available. New Value Not Used 518 requires the result of a formula that subtracts New Value Used from New Value Available. Exposure requires the result of a formula that adds the Invoice Amount (the amount in column D) to the Exposure from the previous line, and subtract from that sum the New Value Used.

A depiction of a presentation of Preference Period Data after combining and applying the OCB and SNV Defenses is shown at FIG. 23 in a spreadsheet format that describes the relationships between the assigned rows and columns used, to calculate the resulting Exposure. For the algorithms of FIG. 23, Payment Time requires the result of a formula subtracting Provided Date from Payment Date and displaying the result in numeric form, preferably as an integer. New Value Payment Time requires the result of a formula subtracting New Value Provided Date from New Value Payment Date and displaying the result in numeric form, preferably as an integer. Protected by OCB requires the result of a formula comparing the Payment Date with the Upper and Lower Ends of the OCB Protected Range and inputting the Invoice Amount if the Payment Time falls within the OCB Protected Range and inputting zero if the Payment Time falls outside the OCB Protected Range. For example,
=IF(F44>=$L$4,IF(F44<=$L$5,D44,0),0) Formula L44:
=IF(F45>=$L$4,IF(F45<=$L$5,D45,0),0) Formula L45:

New Value Available requires the result of a formula comparing the New Value Payment Date with the Upper and Lower Ends of the OCB Protected Range and inputting zero if the New Value Payment Time falls within the OCB Protected Range and inputting the New Value Invoice Amount if the New Value Payment Time falls outside the OCB Protected Range. For example,
=IF(K44>=$L$4,IF(K44<=$L5,0, I44), I44) Formula M44:
=IF(K45>=$L$4,IF(K45<=$L$5,0, I45), I45) Formula M45:

New Value Used requires the result of a formula where if the Exposure on the previous line is greater than New Value Available, then input the value of the New Value Available, otherwise, input the Exposure from the previous line. For example,
=IF(P43>M44,M44,P43) Formula N44:
=IF(P44>M45,M45,P44) Formula N45:

New Value Not Used requires the result of a formula that subtracts New Value Used from New Value Available. For example,
=+M44−N44 Formula 044:
=+M45−N45 Formula 045:

Exposure requires the result of a formula that adds the Invoice Amount (the amount in Column D) to the Exposure from the previous line, and subtract from that sum the Protected by OCB Defense and New Value Used.
=+P43+D44−L44−N44 Formula P44:
=+P44+D45−L45−N45 Formula P45:

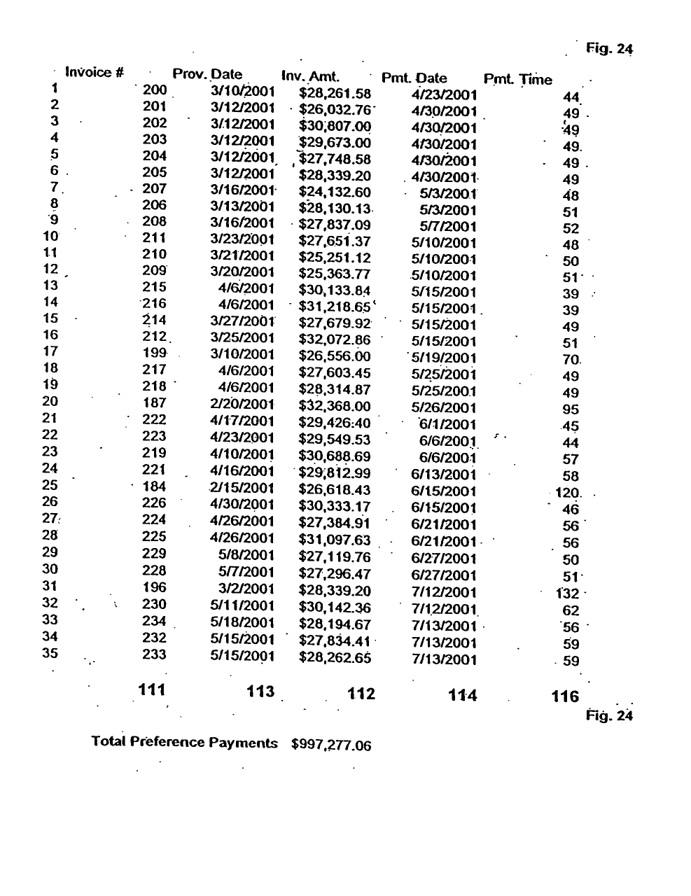

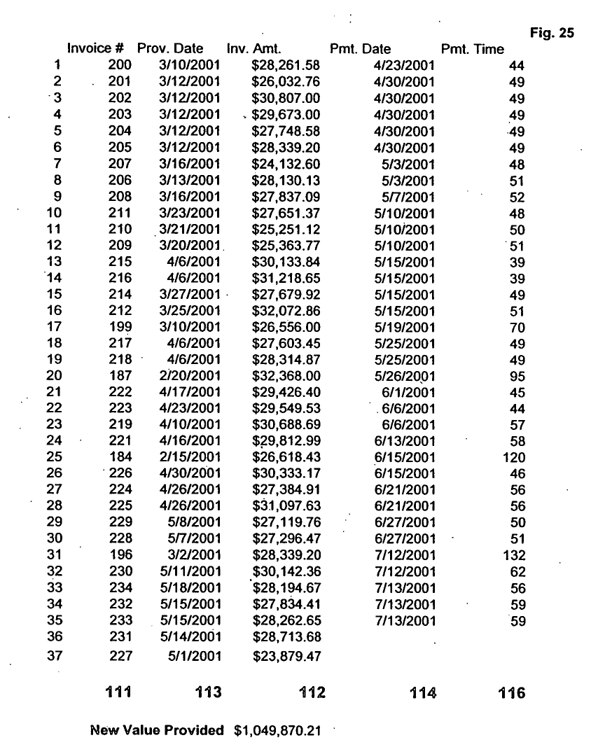

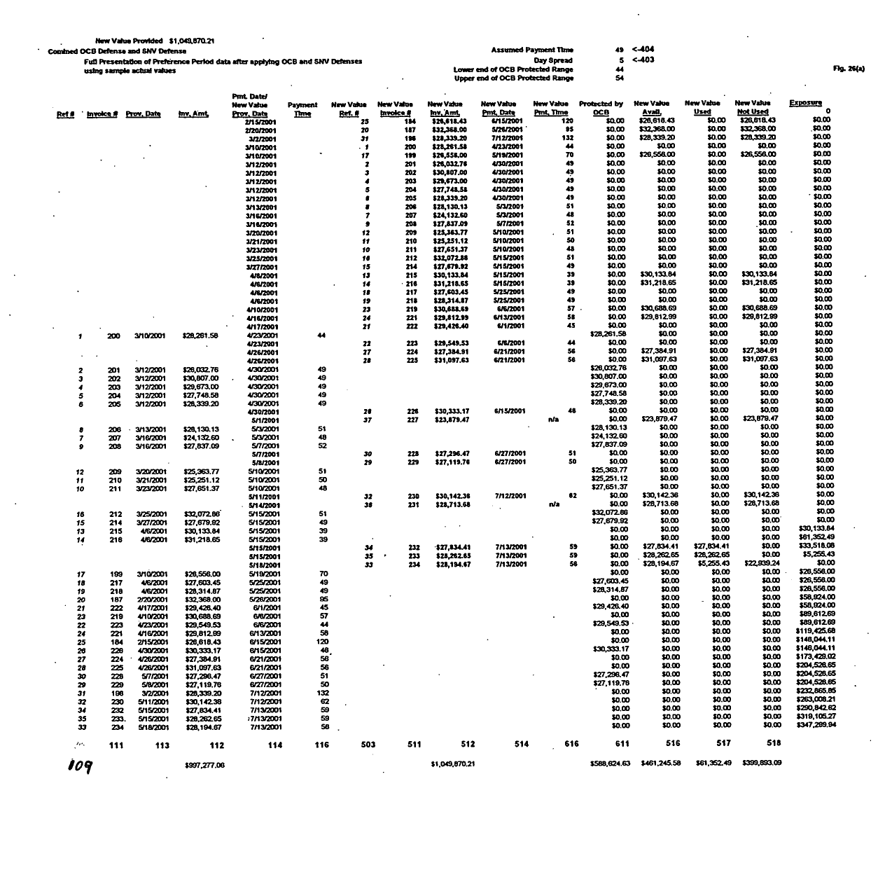

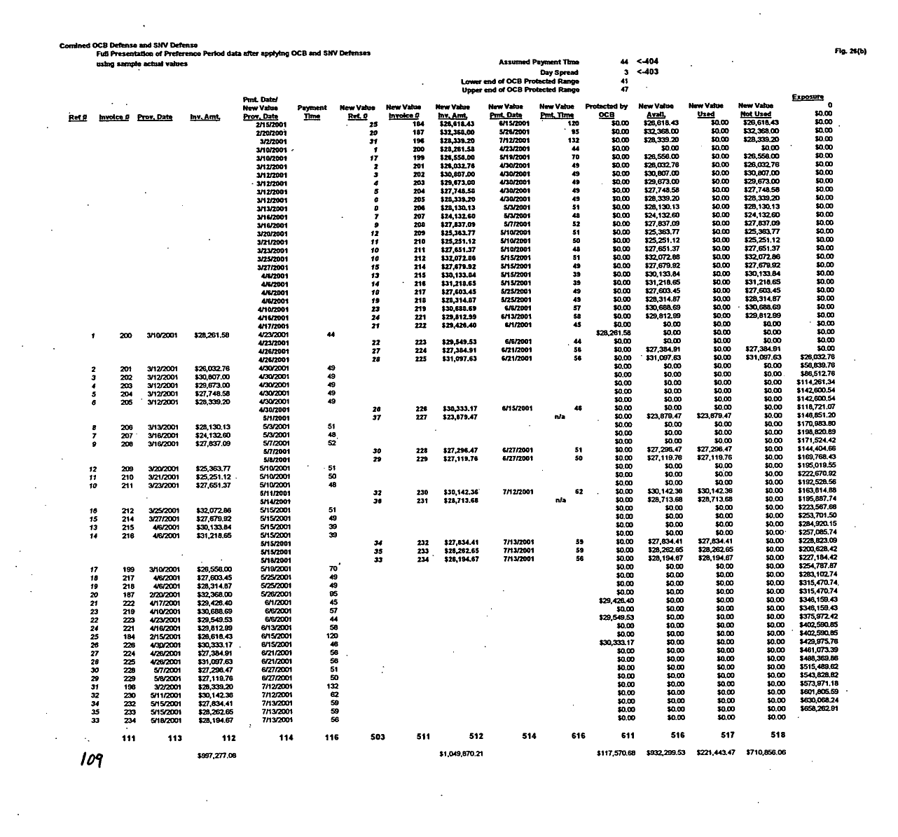

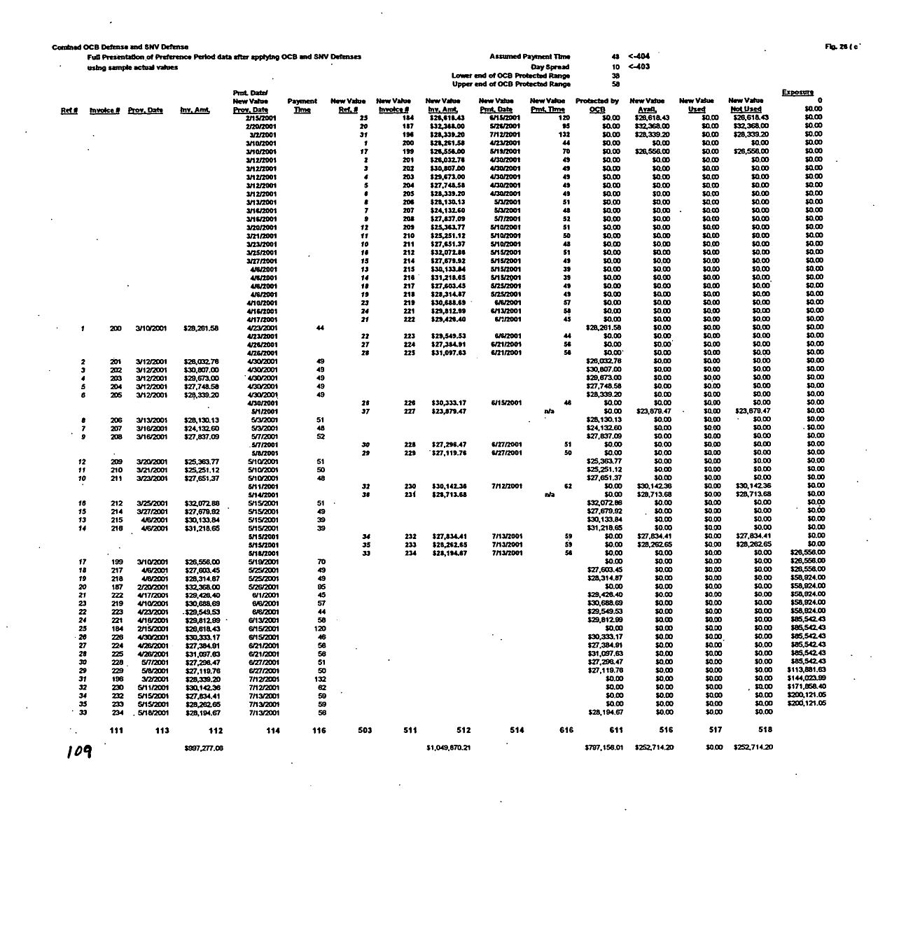

A depiction of the original data (related to Preference Payments) to be used in combining and applying the OCB and SNV Defenses, the total Invoice Amounts of which will equal the total Invoice Amounts 112 in an analysis, such as in FIGS. 26(a), 26(b), and 26(c), is shown at FIG. 24. This figure uses a hypothetical preference period running from Apr. 18, 2001 through Jul. 16, 2001 and sorts the lines of data 102 by payment date 114, excluding goods or services provided within the preference period. A depiction of the replicated data (related to Subsequent New Value) to be used in combining and applying the OCB and SNV Defenses, the total Invoice Amounts 112 of which will equal the total New Value Invoice Amounts 512 in an analysis, such as in FIGS. 26(a), 26(b), and 26(c), is shown at FIG. 25 and includes goods or services provided within the preference period. FIG. 25 also uses a hypothetical preference period running from Apr. 18, 2001 through Jul. 16, 2001 and sorts the lines of data 102 by payment date 114.

A depiction of a full presentation of Preference Period Data after combining and applying the OCB and SNV Defenses using sample values and assuming an Assumed Payment Time 404 of 49 days and a Day Spread 403 of 5 days is shown at FIG. 26(a). A depiction of a full presentation of Preference Period Data after combining and applying the OCB and SNV Defenses using sample values and assuming an Assumed Payment Time 404 of 44 days and a Day Spread 403 of 3 days is shown at FIG. 26(b). A depiction of a full presentation of Preference Period Data after combining and applying the OCB and SNV Defenses using sample actual values and assuming an Assumed Payment Time 404 of 48 days and a Day Spread 403 of 10 days is shown at FIG. 26(c). It is contemplated that the invention can be produced in a format that automatically calculates results for a large range of assumed values for Assumed Payment Time 404 and Day Spread 403 by spreadsheet, database or other software based means as are known in the art. It is further contemplated that the invention can be produced in a format that allows manual input of Assumed Payment Time 404 and Day Spread 403.

Preparing Comprehensive Results

In OCB/SNV presentation step, the results of each combination of OCB and SNV Defenses for each assumption of Assumed Payment Time 404 and Day Spread 403 can be input into a two-dimensional chart, one axis of which will represent the variable the Assumed Payment Time 404 and the other axis of which will represent the variable the Day Spread 403, and for each result, indicate the OCB Protected Range. The intersection of each variable will provide the Exposure After Applying the Ordinary Course of Business and Subsequent New Value Defenses for those assumed values of the variables.

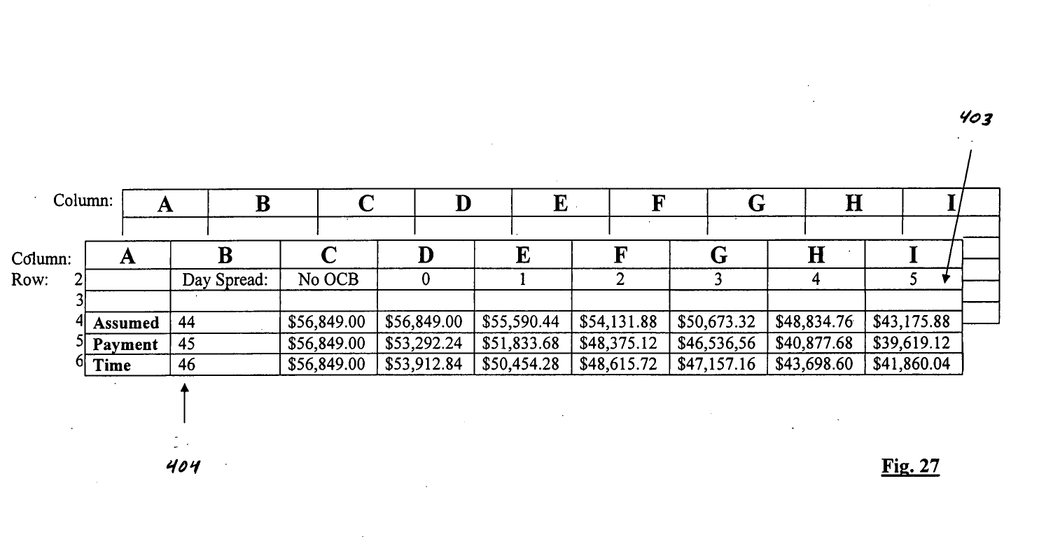

A depiction of a full presentation of the results of each combination of OCB and SNV Defenses for each assumption of Assumed Payment Time 404 and Day Spread 403 in a two-dimensional chart (the values being pulled from the results of applying each set of assumptions) using sample values is shown at FIG. 27. For any analysis, such as the three shown in FIGS. 26(a), 26(b), and 26(c), such analyses may be displayed.

### OTHER EMBODIMENTS OF THE INVENTION

In data preparation-step 110, it is contemplated that any data related to, or method of distinguishing, Preference Payments that could be used to determine whether a Preference Payment was paid within the OCB may be used. For example, data indicating that some Preference Payments were paid by check while other were paid by wire transfer may be used if such distinction could be the basis of determining whether a Preference Payment was paid within the OCB or not.

In data preparation step 110, any other data that may be helpful in distinguishing each Line of Data or in understanding the data, either at this step or in any subsequent step or output display, may be included in the data at this time or at any other time.

In data splitting step 125, it is contemplated that Provided Dates 113 in the Pre-Preference Period that were paid after the Petition Date may, but not need, be included in the Pre-Preference Period data. Such data will likely later be removed from the Pre-Preference Period data as being paid outside the OCB.

In data splitting step 125, it is contemplated that Provided Dates 113 in the Preference Period that were paid after the Petition Date (the date on which a bankruptcy petition related to a Debtor was filed) may, but not need, be included in the Preference Period data.

In display step 150, the invention contemplates presenting the resulting Pre-Preference Period Data and Preference Period Data in a readable format in ascending order by Payment Date 114. The invention also contemplates presenting the resulting Pre-Preference Period Data and Preference Period Data in any format including sorted by Invoice Amount 112, Invoice Date 111, Provided Date 113 or Payment Date 114 in ascending or descending order.

In CENV Payment Time selection step 210, the invention may be set to calculate CENV Payment Time or Times using pre-determined calculations. For example, the invention may use a predetermined number, such as 2, or range of numbers, such as 0, 1, 2 and 3, as the CENV Time so that no manual determination of CENV Time is necessary.

In CENV Payment Time selection step 210, an invention user may choose any CENV Payment Time or Times he or she believes is appropriate, including those that fall outside any range chosen by the user or created automatically by the invention.

Prior to step 210, if the Preference Period Data is not already in the invention due to the manipulations to the original data, the Preference Period Data may be imported or input into the invention so that the following steps may be taken.

In CENV result display step 260, the invention contemplates that multiple results of the application of the CENV Defense, caused by using multiple CENV Times, may be used in subsequent applications of the invention.

In historical period determination step 335, assuming the necessary data exists, the invention may create one or more pre-determined Historical Periods without input from a user.

In OCB data sorting step 410, for calculating the OCB Defense, the Preference Period data used may be the unmodified original Preference Period data with no other Defenses yet applied or may be the Preference Period data that has been modified by other Defenses having been applied to that data.

In OCB payment time selection step 420, it is contemplated that one of the Assumed Payment Times 404 used in calculating the OCB Defense will include the most appropriate. Historical Average Payment Times 303. If the invention user has no Historical Period data or chooses not to use available Historical Periods, the invention user may use Preference Period Data or any other method to determine the Assumed Payment Time(s) 404.

In OCB recalculation step, it is contemplated that all Assumed Payment Times 404 that may be useful in understanding application of Defenses or in negotiation will be included in the range of Assumed Payment Times 404 discussed in step, including the most appropriate Historical Average Payment Times 303 and any other appropriate Assumed Payment Time 404 however determined. If the invention user has no Historical Period data or chooses not to use available Historical Periods, the invention user may use Preference Period Data or any other method to determine the Assumed Payment Time(s) 404.

In SNV data sorting step 505, Reference Numbers 109 may or may not be used in calculating the SNV Defense.

In step 510, columns in the replicated data need not be separated from the original data, although it is easier to understand if the columns are separated and, regardless of method used, it is suggested that the replicated data is distinguished in some way from the non-replicated data.

In the SNV data sorting step 520, it is contemplated that Provided Dates 113 need not be placed after Payment Dates 114 if such dates are the same.

In OCB/SNV data replication step 620, those Lines of Data 102 that represent goods or services provided within the Preference Period but were not paid need not be removed from the original data, but may be retained in the data for demonstrative purposes. If those Lines of Data 102 are removed, they should be placed into the memory so that they may be indicated in the results as removed.

In step 625, it is contemplated that Provided Dates 113 need not be placed after Payment Dates 114 if such dates are the same.

Instep 625, the Payment Date 114/New Value Provided Date column maybe split into two separate columns, Payment Date 114 and New Value Provided Date, for display purposes.

In OCB protection step 640, the Assumed Payment Time 404, Day Spread 403 and OCB Protected Range that correspond to the results related thereto may be placed in any useful place within the data and need not be displayed.

### OTHER EMBODIMENTS

In General:

Specific embodiments mentioned above are applicable to any step to which the specific embodiment may apply, regardless of whether that step is specifically referenced. Specific embodiments mentioned above do not restrict any of the general other embodiments discussed here. In general, for example, in invoice reconciliation step 140 and Historical Period data display step, the invention adds total Invoice Amounts 112 for the Pre-Preference Period and the total Invoice Amounts 112 for the Preference Period such that the total of the Invoice Amounts 112 can be reconciled with the total Invoice Amounts 112 from the original data. The invention contemplates other methods of reconciling the manipulated data to the original data in order to ensure that all original data was included in the manipulations, such as adding all of the Invoice Numbers 111, Provided Dates 113 or Payment Dates 114 or by other means.

It is generally understood that the same portion of a Preference Payment may not be reduced by more than one Defense, that is, that once a Defense protects a Preference Payment (or portion thereof) and thus decreases Exposure, another Defense cannot be applied to further reduce Exposure by that same Preference Payment (or portion thereof). However, some practitioners believe that this is acceptable in certain circumstances. The invention contemplates that either interpretation of the Code and the law may be made.

The Code indicates that only if no other Defense applies to shield a Preference Payment can the SNV Defense be applied. Nevertheless, the Invention contemplates that the SNV Defense need not be applied last in order.

For each separate step described in the invention, manipulations described in previous steps can be inserted into future steps if the previous step is unused. Steps that are repeated, such as determining Payment Times in the Manipulation of data section and the OCB Defense section, need not be repeated.

It is contemplated that application of Defenses and manipulations and calculations related thereto maybe performed in any order a user may elect. Any interpretation of the Code and related law may be used when using the invention, and the use of the invention is not restricted to those methods recognized by the Code and related law. For example, some practitioners interpret the Code and law to mean that for the SNV Defense to be applicable, the new value provided must remain unpaid, and the invention contemplates this interpretation. For another example, some practitioners read the Code and related law as allowing the application of the “net result rule” that allows, when applying the SNV Defense, Exposure to decrease below zero; the invention contemplates its use making such interpretation. For another example, some practitioners interpret the Code and related law to mean that SNV may not be applied to any Preference Payment other than the single Preference Payment immediately prior to the SNV provided, and the invention contemplates its use making such interpretation. In each example, and in any other interpretation of the Code and related law, the invention contemplates using any and all interpretations of the Code and/or related law.

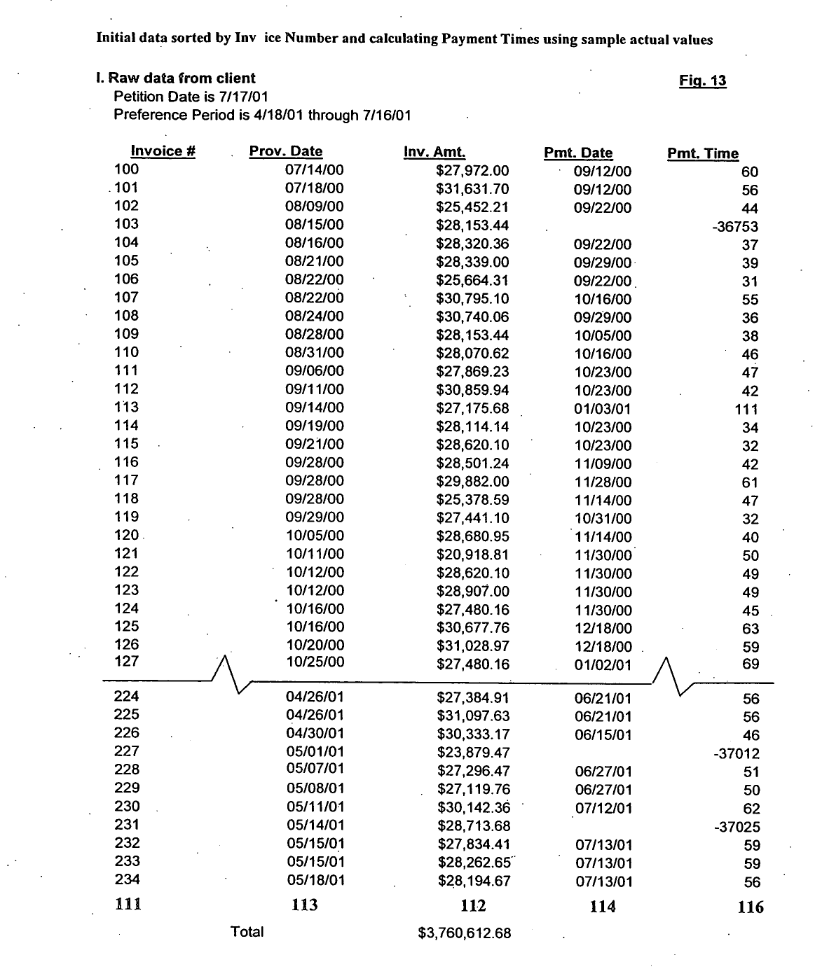

The descriptions of the ordering of data, be it in columns, rows or otherwise, whether for display or not, are simply one way of ordering and manipulating the data. Any method of ordering and manipulating data may be used. For example, the column headings in any of the FIGS. 8-27 may be rearranged or renamed. Other columns helpful to the calculation and understanding of the invention may be added and columns may be removed. For another example, in data sorting step 120 (the splitting of the data into Preference Period and Pre-Preference Period data), the invention may sort the data in descending order or in any other way that would help yield the result sought or to display the results in a meaningful way.

It is contemplated that numerous reconciliation points may be used to verify that the data used in any previous step has been manipulated properly in the current step. For example, invoice totaling step 130 indicates one such reconciliation point, where the invention adds total Invoice Amounts 112 for the Pre-Preference Period and the total Invoice Amounts 112 for the Preference Period such that the total of the Invoice Amounts 112 can be reconciled with the total Invoice Amounts 112 from the original data. While some of those reconciliation points are indicated, it is contemplated the invention recognizes that any reconciliation point that would be helpful to verify that the data has been correctly manipulated and calculated may be used. For example, if it would be helpful to verify that the number of Invoice Numbers 111 in the Preference Period created in data splitting step 125 matches the number of Invoice Numbers 111 in the Preference Period used in combined OCB/SNV Payment Time calculation step 610, such a reconciliation point maybe created and used. Likewise, the Preference Period Invoice Numbers 111, Invoice Amounts 112, Provided Dates 113 and Payment Dates 114 may all be used as reconciliation points since they may all be recognized by the invention as numeric values, added together and compared with the same sums at any point of the manipulations and calculations of the invention to verify that all pieces of data are included in later steps.

It is contemplated that any of the steps of the invention that utilize automatic data manipulation, automatic calculations, or automatic determinations of variables maybe circumvented by manual processes or skipped if appropriate. For example, for the CENV Defense, CENV Payment Time selection step 210 through CENV result display step 260 may be circumvented by manually determining the result of applying Payment Time selection step 210 through CENV result display step 260. For another example, in step 640, rather than having the invention determine which Payment Times 116 fall outside the OCB Protected range, such determination can be performed manually. For another example, in step 640, entering the result of the previous step in the Protected by OCB Defense column can be done manually. For another example, in step 650, values in the New Value Available 516, New Value Used 517 and New Value Not Used 518 columns may be manually determined and inserted. For another example, in the combined OCB/SNV analysis step 670, Exposure amounts may be inserted manually, including in those situations where the Exposure falls below 0 such that 0 must be inserted in the Exposure column.

Any step requiring the manipulation or removal of a piece of data or Line of Data 102 that may be accomplished automatically by the invention may be accomplished manually by the use of highlighting such piece of data or Line of Data 102 in any manner or method, including highlighting such using a mouse and clicking on such, using keyboard keys, or by inserting a new column and clicking or inserting an alpha/numeric character into that new column to indicate that such piece of data or Line of Data 102 is to be manipulated or removed.

Any appropriate data may be input at any step, regardless of whether that data is a product of any steps of the invention or produced by any other method or provided by any Source.

Any step or series of steps may be used independently of any other step or series of steps. For example, the OCB Defense may be independently applied to data without the utilization of any other steps of the invention. For another example, the CENV or SNV Defenses may be applied to data independently without the utilization of any other steps of the invention.

While the invention contemplates the appropriate number of steps to properly display useful output and condenses certain steps into one step, it is contemplated that, depending on the invention user's needs or for any other reason, more or fewer steps may be used in order to allow better understanding of the manipulations, calculations and results of the invention.

Reference Numbers 109 maybe inserted at any appropriate point, such as at data preparation step 110, but it is believed that Reference Numbers 109 are better used only for Preference Period data as contemplated by the invention at OCB/SNV Reference Numbering step 615, and they need not be used at all.

If certain steps are skipped, the appropriate steps necessary to perform later data manipulations, calculations or results are not ignored. For example, in combined OCB/SNV Payment Time calculation step 610, if the Payment Time 116 has not been calculated because Payment Time Calculation step 305 through Historical Period data display step have been skipped, the Payment Times 116 within the Preference Period would necessarily have to be calculated.

Reference to “amount of payments” is the value of the payment received, whether that payment is a Preference Payment or not, which is the Invoice Amount 112 of the Line of Data 102 related to any payment.

The invention contemplates all useful or informative formats of output results and summaries thereof, whether displayed in combination with other output results or separately.

It is contemplated that explanatory descriptions of output results maybe used in combination with the output results, whether displayed in combination with output results or separately. Such explanatory descriptions may be added manually by a user or may be automatically inserted by the invention.

Any output display may be modified, condensed or expanded into any useful format. For example, the output may be modified to show only one line for each Payment Time so that the two Lines of Data whose Payment Times are 44 days will be combined into one Line of Data for Display Purposes.

The embodiment of the invention described herein assumes that other Defenses are applied prior to the application of the OCB and SNV Defenses, whether applied separately or combined. Changes in assumptions made to Defenses other than the OCB and SNV Defenses will likely affect the data used in the application of the OCB and SNV Defenses. The invention contemplates that to the extent assumptions must be made to apply Defenses other than the OCB and SNV Defenses, numerous assumptions, including a range of assumptions, may be made prior to the application of any Defenses such that numerous data sets may be used in applying the OCB and SNV Defenses. For example, when applying the CENV Defense, one may choose a range of 0 to 5 days for the assumption of the appropriate CENV Time. Choosing this range may result in six different Exposure results and six different data sets to which the OCB and SNV Defenses may apply. The invention contemplates providing multiple results based on numerous assumptions made to Defenses other than OCB and SNV Defenses as well as numerous assumptions made in applying the OCB Defense.

In any SNV Defense application, be it separate or combined with any other Defense, those Lines of replicated Data related to Payment Dates prior to the first Preference Payment may be removed from the output results, since no New Value may be applied prior to the first Preference Payment. Likewise, any Lines of replicated Data that relate to Payment Dates that occur after a Preference Payment, but do not reduce Exposure, may be removed from the output results for illustrative purposes.

It is contemplated that only those Lines of Data affecting a Recipient's Exposure may be shown as output results.

It is contemplated that the invention include a search mechanism such that a user may input a piece of data and the invention will find that piece of data in each place it occurs in the invention's data sets, whether that data set be input, output or other manipulated data. For example, using any method, a user may prompt the invention to find Invoice Number 13228, and the invention would then find and highlight the first occurrence of that Invoice Number in its sets of data. The invention may then prompt the user as to whether the user chooses to view the next occurrence of Invoice Number 13228 and will find that next occurrence if the user so indicates, and so on.

The above description is not intended to limit the meaning of the words used in the following claims that define the invention. Rather, it is contemplated that other variations and future modifications in structure, function or result will exist that are not substantial changes and that all such unsubstantial changes in what is claimed are intended to be covered by the claims.

1. In a data processing medium, a method of calculating the contemporaneous exchange for new value defense for one or more preference payments comprising the steps of:
creating in said data processing medium, one or more lines of data related to each of said preference payments, each of said lines of data including an expression of an invoice amount, a payment date and a provided date;
calculating a payment time for each of said preference payments, said calculation being a function of said payment date and said provided date;
selecting a CENV payment time;
comparing said selected CENV payment time to said calculated payment time of said preference payments; and
differentiating those of said preference payments having payment times that are less than or equal to said CENV payment time from the remainder of said preference payments.

2. The method of claim 1 further comprising:
repeating said comparing step and said differentiating step for a plurality of said selected CENV payment times.

3. The method of claim 1, wherein said data processing medium is one of a spreadsheet software program or a database software program.

4. The method of claim 2 further comprising:
displaying concurrently the result of said differentiating step for each of said selected CENV payment times.

5. The method of claim 1 further comprising:
summing said invoice amounts for those of said preference payments having payment times that are less than or equal to said CENV payment time.

6. The method of claim 5 further comprising:
repeating said comparing step, said differentiating step and said summing step for a plurality of said selected CENV payment times.

7. The method of claim 6 further comprising:
displaying concurrently the result of said summing step for each of said selected CENV payment times.

8. In a data processing medium, a method of calculating the ordinary course of business defense for one or more preference payments comprising the steps of:
creating in said data processing medium, one or more lines of data related to each of said preference payments, each of said lines of data including an expression of a payment date and a provided date;
calculating a payment time for each of said preference payments, said calculation being a function of said payment date and said provided date;
selecting an assumed payment time;
selecting a day spread;
calculating an OCB protected range, said calculation being a function of said assumed payment time and said day spread;
comparing said OCB protected range to said calculated payment time of said preference payments; and
differentiating those of said preference payments having payment times that fall within said OCB protected range from the remainder of said preference payments.

9. The method of claim 8 further comprising:
repeating said comparing step and said differentiating step for a plurality of said OCB protected ranges.

10. The method of claim 8, wherein said data processing medium is one of a spreadsheet software program or a database software program.

11. The method of claim 9 further comprising:
displaying concurrently the result of said differentiating step for each of said OCB protected ranges.

12. The method of claim 8 wherein said assumed payment time is an historical average payment time.

13. The method of claim 11 wherein said displaying step sorts each set of said results by said payment time of said preference payments in chronological order.

14. The method of claim 8 further comprising:
repeating said comparing step and said differentiating step for at least 12 of said OCB protected ranges.

15. In a data processing medium, a method of calculating the ordinary course of business defense and the subsequent new value defense for one or more preference payments comprising the steps of:
creating in said data processing medium, one or more lines of data related to each of said preference payments, each of said lines of data including an expression of a payment date, a provided date and an invoice amount;
calculating a payment time for each of said preference payments, said calculation being a function of said payment date and said provided date;
selecting an assumed payment time;
selecting a day spread;
calculating an OCB protected range, said calculation being a function of said assumed payment time and said day spread;
comparing said OCB protected range to said calculated payment time of said preference payments;
differentiating those of said preference payments having payment times that fall within said OCB protected range from the remainder of said preference payments;
summing said invoice amounts for those of said preference payments having payment times that fall within said OCB protected range;
sorting said lines of data chronologically based on said payment date;
distinguishing lines of data related to said preference payments having payment times that fall within said OCB protected range from the remainder of said lines of data;
calculating the subsequent new value associated with each of said preference payments remaining after said distinguishing step;
summing said subsequent new value associated with each of said preference payments remaining after said distinguishing step; and
combining the sum of said invoice amounts for those of said preference payments having payment times that fall within said OCB protected range with the sum of said subsequent new value associated with each of said preference payments remaining after said distinguishing step.

16. The method of claim 15 wherein said data processing medium is one of a spreadsheet software program or a database software program.

17. The method of claim 15 further comprising:
selecting a CENV payment time;
comparing said selected CENV payment time to said calculated payment time of said preference payments;
differentiating those of said preference payments having payment times that are less than or equal to said CENV payment time from the remainder of said preference payments; and
distinguishing lines of data related to said preference payments having payment times that are less than or equal to said CENV payment time from the remainder of said lines of data prior to said sorting step.

18. The method of claim 17 wherein said data processing medium is one of a spreadsheet software program or a database software program.

19. The method of claim 15 further comprising:
displaying concurrently the result of said calculations of said ordinary course of business defense and said subsequent new value defense.

20. The method of claim 17 further comprising:
displaying concurrently the result of said calculations of said contemporaneous exchange for new value defense, said ordinary course of business defense and said subsequent new value defense.

21. The method of claim 15 further comprising:
repeating said comparing step, said differentiating step and said distinguishing step for a plurality of said OCB protected ranges.
